(19) United States
(12) Patent Application Publication
(10) Pub. No.: US 2015/0112776 A1
(43) Pub. Date: Apr. 23, 2015

(54) PROMOTION MANAGEMENT METHODS AND APPARATUS

(71) Applicant: F Elevent Software, LLC, Arlington Heights, IL (US)

(72) Inventors: Matthew Steven Murphy, Arlington Heights, IL (US); Jacob W. Beckley, Arlington Heights, IL (US)

(73) Assignee: F Elevent Software, LLC, Arlington Heights, IL (US)

(21) Appl. No.: 14/061,473

(22) Filed: Oct. 23, 2013

(51) Int. Cl. G06Q 30/02

(52) U.S. Cl. CPC G06Q 30/0211
USPC 705/14.13

(57) ABSTRACT

A system, method, and apparatus for managing promotions are disclosed. An example method includes receiving in a server an indication of a sale of a promotional item from a sales terminal, the promotional item being specified by a promoter for a promotional competition to be carried out by a group of sales associates, the indication including an identifier of a sales associate who sold the promotional item, determining a quantity of the promotional items sold based on the received indication and a previous quantity of the promotional items sold by the sales associate, determining relationships among the group of sales associates based on the quantity of promotional items sold by the sales associates, and sending to a computer system of the promoter information indicative of the quantity of promotional items sold respectively by the sales associates and information indicative of the determined relationship among the group of sales associates.

### BACKGROUND

In sales, managers have used promotions to encourage employees to push or recommend the sale of particular products/services to customers. For instance, in the restaurant industry, managers commonly specify a drink or food special and offer a cash reward to the employee that sells the most of that product in a given time period. In these instances, the managers tally the product sales for each of the employees and award the top one or more employees with a cash reward at the end of the promotional period. Similar to the food industry, other types of merchants or manufacturers provide promotions for clothing, electronics, sporting goods, services, automobiles, boats, groceries, liquor, etc.

FIG. 1 is a diagram of a known multi-tier promotional environment 100 that includes a product manufacturer 102, a distributor 104, and a retailer 106, which employs sales associates 108. In this example, the manufacturer 102 produces products (e.g., food, clothing, electronics, etc.), which are transported to the retailer 106 via the distributor 104. The sales associates 108 sell the products to customers.

In some instances, the promotional environment 100 also includes a promotion agency 110. For example, many states and the federal government have laws restricting liquor manufacturers from directly advertising or promoting their beverages to consumers. Instead, these manufactures 102 promote their products through the services of a promotion agency 110. In a typical example, the manufacturer 102 provides the promotion agency 110 money and instructions for a promotion. In return, the promotion agency 110 interfaces with the retailers 106 to manage the promotion including the awarding of prizes to sales associates that sell the most of a specified promotional item.

In addition to using promotion agencies for liquor, many manufactures and/or retailers may use the experience of a promotion agency 110 to promote the sale of other types of products. For example, it is not uncommon for clothing manufacturers to use promotion agencies to operate promotions for certain types/brands of clothing. As an alternative to promotion agencies, some manufactures and/or retailers may themselves operate promotions.

For a given promotion in the illustrated example of FIG. 1, the manufacturer 102 (the promoter in this example) specifies which product is to be promoted (e.g., the promotional item). It should be appreciated that in other examples, the distributor 104 and/or the retailer 106 may specify the promotion. In this example, the manufacturer 102 ships the product to the retailer 106 via the distributor 104. At about the same time, the manufacturer 102 provides the promotion agency 110 with compensation (e.g., money) to operate a promotion of the specified product. The manufacturer 102 may plan with the promotion agency 110 the aspects or parameters the promotion including, for example, advertising, promotional goods/prizes, promotional time period, etc.

The promotion agency 110 informs the retailer 106 of the promotion. The promotional agency 110 also provides the retailer 106 with the promotional goods/prizes, which are specified to be awarded to a predetermined quantity of sales associates 108. The predetermined quantity may be based on sales quotas, a ranking, sales per time period etc. (e.g., awarding the top three sales associates 108 with the greatest quantity of sales of the promotional product).

The retailer 106 informs the sales associates 108 of the promotion. During the promotional period, the retailer 106 maintains sales records as to how many promotional products were sold by each sales associate 108. At the end of the promotional period, the retailer 106 determines which sales associates 108 met the predetermined conditions and accordingly awards the promotional goods/prizes.

A known issue with this promotional environment 100 is that the manufacturer 100 has relatively limited feedback regarding the success of the promotion. The reason for this limited feedback is because the retailer 106 and the promotion agency 110 do not provide promotional sales data to the manufacturer 102. Instead, in known promotional environments 100, the distributor 104 receives retailer data that specifies how much of the promotional product was sold to the retailer or shipped to the retailer and the manufacturer 102 receives distribution data that specifies how much of the promotional product was shipped or transported to the distributor 104. The manufacturer accordingly has limited, if any, visibility as to how many promotional products were sold by each sales associate, retail location or retailer. In addition, the promotion agency 110 does not have any data regarding how many promotional products were sold.

This known issue is particularly frustrating for manufacturers 102 because they have limited visibility regarding the success of a promotion. Oftentimes, the manufacturers 102 have to rectify case or pallet shipment data associated with the timing of the promotion. Even then, the manufacturers 102 do not have an accurate representation as to how many products were sold as a direct (or indirect) result of the promotion.

In some instances, manufacturers 102 may contact retailers 106 directly for the retail data. However, each retailer 106 may track sales differently and/or in different formats. Separate retailers of the same franchise may even track promotions differently. As a result of these differences, manufactures 102 have to manually review and format data into a common standard to determine the effect of a promotion.

In addition to the manufacturers 102 having limited promotion visibility, sales associates 108 also have limited information regarding a promotion. For instance, each retailer 106 may provide sales associates 108 with a verbal announcement, e-mail, or paper flier providing the details of a promotion. The quality and amount of information may vary across all the sales associates 108 for each promotion.

There is also limited transparency for sales associates 108 regarding the results of a promotion. For instance, the retailer 106 may provide periodic updates regarding the total promotional products sold for each sales associate 108. The sales associates 108 do not have access to sales data to know in real-time how they rank with their peers. Further, after a promotion ends, the sales associates 108 have nothing to show for the promotion other than the few that are awarded a prize. A need accordingly exists to provide promoters and sales associates with measurable real-time insight into the performance and/or metrics of promotions.

### SUMMARY

The present disclosure provides a new and innovative system, method, and apparatus for managing promotions. A promotion server is configured to host a promotion management system that enables promoters to provide information regarding a promotion including identifiers of promotional items, a promotional time period, a description of the promotion, and a description of the rules/awards. The promotion server uses the received promotion information to create a web page, application, mobile application, and/or application interface descriptive of the promotion for sales associates and promoters. During the promotion, the promotion server compiles sales data to determine how many promotional items were sold by each sales associate participating in the promotion. The promotion server also determines relationships among the participating sales associates. The promotion server transmits the quantity of sales and relationship data to the sales associates and promoters (via the web page and/or application) to provide real-time or near real-time status of a promotion.

In an example, a method includes receiving in a server an indication of a sale of a promotional item from a sales terminal, the promotional item being specified by a promoter for a promotional competition to be carried out by a group of sales associates, the indication including an identifier of a sales associate included within the group of sales associates who sold the promotional item. The method also includes determining a quantity of the promotional items sold by the sales associate based on the received indication and a previous quantity of the promotional items sold by the sales associate and determining relationships among the group of sales associates based on the quantity of promotional items sold by the sales associates. The method further includes sending to a computer system of the promoter information indicative of the quantity of promotional items sold respectively by the sales associates and information indicative of the determined relationship among the group of sales associates. In this example method, the promoter is remotely located from the group of sales associates.

Additional features and advantages of the disclosed system, method, and apparatus are described in, and will be apparent from, the following Detailed Description and the Figures.

### BRIEF DESCRIPTION OF THE FIGURES

FIG. 1 shows a diagram of a known prior art promotional environment.

FIGS. 2 to 4 show diagrams of example promotional environments including a promotion server, according to example embodiments of the present disclosure.

FIG. 5 shows an example functional diagram including the promotion server of FIGS. 2 to 4, according to an example embodiment of the present disclosure.

FIG. 6 shows a diagram of an example data structure compiled by a point-of-sale server of FIG. 5 using promotional item identifiers provided by the example promotion server of FIGS. 2 to 5.

FIG. 7 shows a diagram of an example profile page created for a promoter by the example promotion server of FIGS. 2 to 5.

FIG. 8 shows a diagram of an example registration web page provided by the promotion server of FIGS. 2 to 5 to sales associates at a time when an account is initially configured.

FIGS. 9 and 10 show diagrams of an example promotion registration web page provided by the promotion server of FIGS. 2 to 5 to promoters to create a promotion.

FIG. 11 shows a diagram of a web page provided by the promotion server of FIGS. 2 to 5 to enable a promoter to specify a drink special as a promotional item.

FIG. 12 shows a diagram of an example promotion web page that is created by the promotion server of FIGS. 2 to 5.

FIG. 13 shows a diagram of an example data structure created by the promotion server of FIGS. 2 to 5 including a quantity of sales of a promotional item for sales associates and a corresponding ranking.

FIGS. 14 and 15 show diagrams of sales associate promotion pages that are created by the promotion server of FIGS. 2 to 5.

FIG. 16 shows a diagram of an awards web page that is provided to a sales associate device via the promotion server of FIGS. 2 to 5.

FIG. 17 is a functional block diagram showing electrical systems of an example computing device (e.g., a promotion server, a sales associate device, a point-of-sale system, a promoter system) of FIGS. 2 to 5.

FIG. 18 shows a flow diagram illustrating example procedures to create a promotion, according to an example embodiment of the present invention.

FIG. 19 shows a flow diagram illustrating example procedures to manage a promotion, according to an example embodiment of the present invention.

FIG. 20 shows a diagram of a promotion web page that is accessed by a promoter by selecting one of the listed promotions listed in FIG. 7

### DETAILED DESCRIPTION

The present disclosure relates in general to a method, system, and apparatus to manage promotions, and in particular, to providing a hosted service that provides real-time promotion information and feedback to product/services promoters and sales associates. As discussed herein, promoters include any manufacturer, distributor, restaurateur, franchisor, franchisee, retailer, promotion agency, etc. that creates or originates a promotion (e.g., a promotional campaign or promotional competition) for sales associates to encourage the sale of specified products and/or services. The promoter may include an entity that is separate and distinct from the sales associates. For example, the promoter may be a manufacturer, distributor, promotion agency, etc. Additionally or alternatively, the promoter may also include the same organization (e.g., a retail or franchise organization) that employs the sales associates.

Sales associates include any employee or contracted individual that sells or manages the sale of products/services. These associates can include, for example, waiters/waitresses, servers, sales associates, dealers, baristas, and bar tenders. As described herein, sales associates associated with a promotion can include sales associates employed at the same retail location, different locations of the same retailer, and/or different locations of different retailers.

As discussed herein, a promotional item is a good (e.g., a product) or service that is specially designated by a promoter for a period of time (e.g., a promotional time period). The special designation by the promoter is used to encourage sales associates to sale or at least recommend the sale of the promotional item to customers. A promotional item can include, for example, a product associated with a restaurant/bar including an entree, an appetizer, a dessert, a dinner package, a drink type, a liquor, and/or a beverage. A promotional item can also include a travel or entertainment-based product including a vacation package, an airline flight, a cruise, a hotel room, a rental car, entertainment tickets, electronic media (e.g., a movie), etc. A promotional item can further include a manufactured good including, for example, an electronic device, clothing, automobiles, appliances, furniture, building supplies, etc.

As disclosed herein, the example method, system, and apparatus provide a hosted promotional service (via a website, application, and/or program) that enables a promoter to configure a promotion and view in real-time promotional sales. A promoter can use the service to manage multiple promotions among one or more different types of promotional items sold at different retailers. Though this framework, a promoter can track how many promotional items are sold by each sales associate, sold at each retail location, sold within a specific geographic region, sold within a time period, etc. The example method, system, and apparatus also enable promoters to interact directly with sales associates by enabling the promoters to directly provide awards, message sales associates, and request feedback from sales associates regarding a promotion.

The example the method, system, and apparatus disclosed herein also provide a hosted promotional service that provides an engaging and/or rewarding platform for sales associates, thereby further encouraging their participation in a promotion. The method, system, and apparatus provide real-time tracking application or hosted environment that shows each sales associate how many promotional items they have sold and how they rank in comparison to other sales associates. The method, system, and apparatus may also enable sales associates to view a history of past promotions in which they have participated and future planned promotions. The method, system, and apparatus may further provide sales associates virtual rewards (such as badges, level promotions, etc.) that are displayable in a virtual trophy case, redeemable awards (e.g., gift cards, bitcoins, store credit, manufacturer credit), and/or tangible awards (e.g., clothing, sports equipment, travel/entertainment tickets, money, etc.).

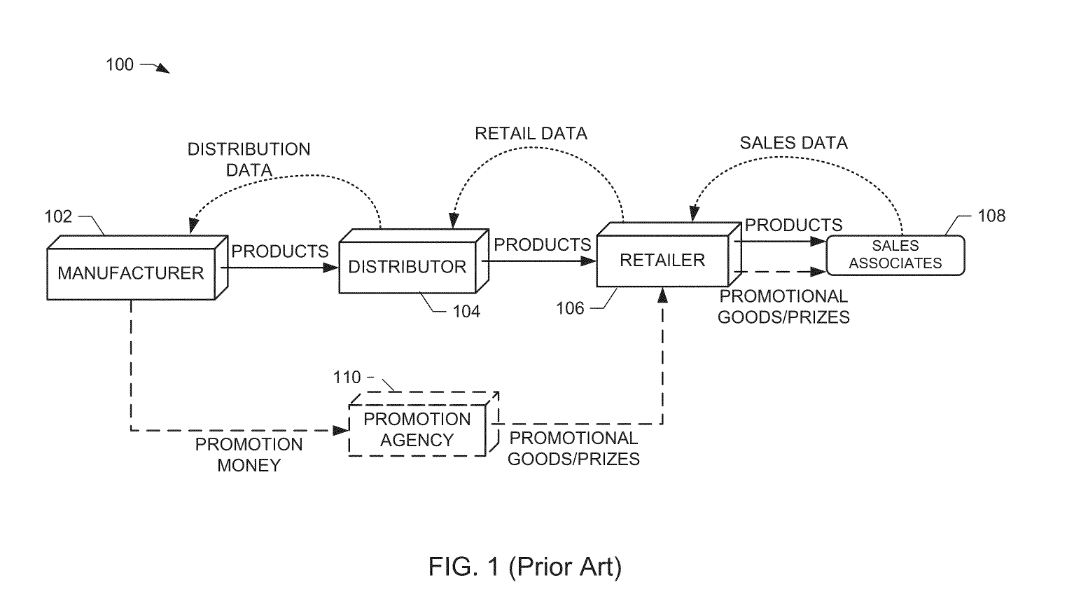

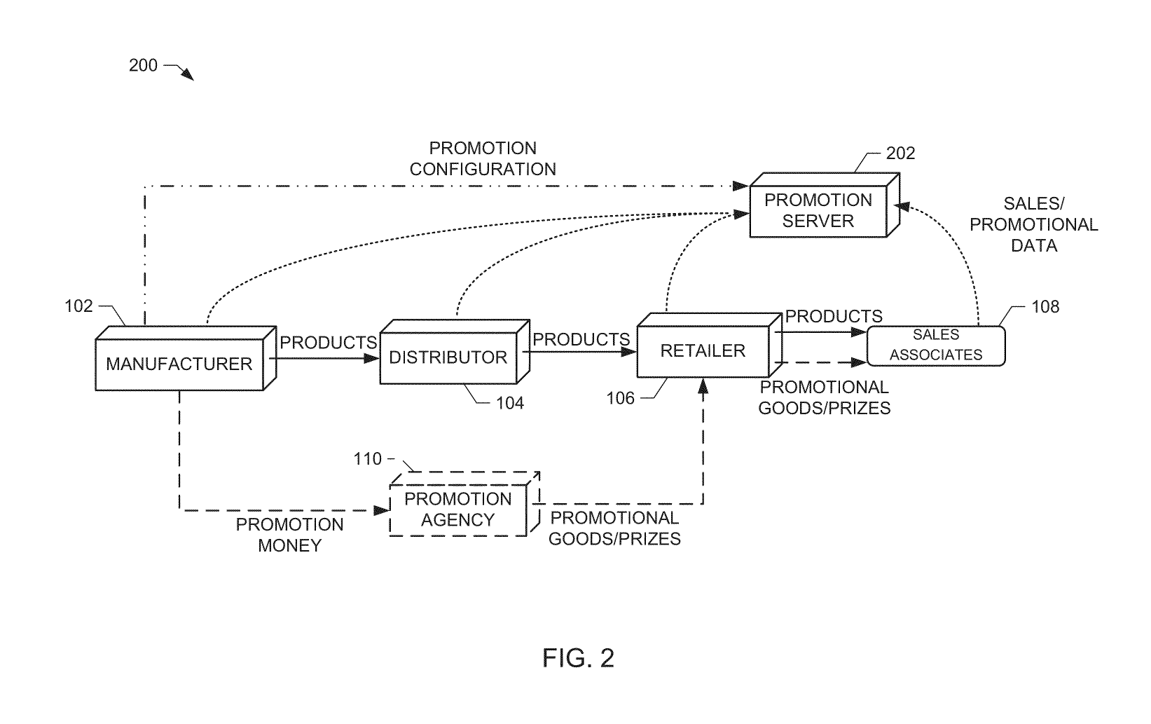

FIGS. 2 to 4 show diagrams of example promotional environments that may use the method, system, and apparatus disclosed herein. In particular, FIG. 2 shows a promotional environment 200 that includes a manufacturer 102, a distributor 104, a retailer 106, sales associates 108, and a promotion agency 110 similar to FIG. 1. In addition, the promotional environment 200 includes a promotion server 202, which is configured to host promotions, as described in further detail below.

In FIG. 2, the manufacturer 102, the distributor 104, the retailer 106, and or the promotion agency 110 may access the promotion server 202 to configure a promotion. The promotion server 202 provides an interface that guides a promoter through the configuration process including, for example, specifying the promotional item, a duration of the promotion, prizes, rules, and/or which sales associates are eligible to participate. Responsive to receiving the configuration information, the promotion server 202 notifies the appropriate sales associates 108 (and/or the retailer 106) of the promotion. The promotion server 202 enables the sales associates 108 to register for the promotion. In other instances, the promotion server 202 automatically registers the sale associates 108 specified by the manufacturer 102. For example, the manufacturer 102 may specify that the retailer 106 is to participate in the promotion, causing the promotion server 202 to register all of the sales associates 108 associated with the retailer 108.

It should be appreciated that in some instances, the promotion server 202 replaces the promotion agency 110. In these instances, the promotion server 202 receives promotion money from the manufacturer 102, informs sales associates 108 of the promotion, and provides promotional goods/prizes to the top performing sales associates. It should be noted that the promotion server 202 is not intended to replace the role of the promotion agency 110 where the use of a promotion agency is mandated by state or federal law.

In other instances, the promotion server 202 is configured to operate in conjunction with the promotion agency 110. For instance, the promotion agency 110 may receive promotion money from a manufacturer 102 and distribute goods/prizes. However, the promotion agency 110 may operate the promotion through the services provided by the promotion server 202 (e.g., distribution of information, communication with sales associates 108, management of sales data).

During a promotion, the promotion server 202 receives sales data from the sales associates 108. In some instances, point-of-sale terminals (or a point-of-sales system) at the retailer 106 are configured to transmit sales data to the promotion server 202 for specified promotional items. The sales data also includes an identifier of the sales associate that made the sale and a time/date of the sale. In other instances, the sales associates 108 may provide sales data to the promotion server 202. In yet other instances, a server used by the retailer 106 provides compiled sales data at periodic times. For instance, a retailer server could transmit sales data every hour. Alternatively, the retailer 106 can provide the promotion server 202 access to compiled sales or transaction data.

For the received sales data, the example promotion server 202 updates the promotional sales total for the appropriate sales associates. The example promotion server 202 may also store to a data structure an indication of the sale and a time of the sale to later determine an average (hourly, weekly, monthly, etc.) quantity of sales for the sales associates 108. Additionally, the promotion server 202 determines relationships between the sales associates 108 based on the received sales data. Determining relationships can include revising a ranking or ordering of the sales associates 108, revising a listing as to which sales associates 108 are in position to receive an award, revising a status of the sales associates, etc. At the end of a promotional period, the promotion server 202 is configured to accumulate the total promotional items sold per sales associate 108 and determine which of the sales associates 108 are to be awarded based on specified rules.

The example promotion server 202 makes this sales data and relationships available to the promoter (e.g., the manufacturer 102), the sales associates 108, the retailer 106, and the distributor 104. The manufacturer 102 uses this information to determine in real-time or near real-time how a promotion is affecting sales of a promotional item, which sales associates and/or retailers are more effective at selling a promotional item, and/or at which times the promotional items have been sold. The promotion server 202 accordingly provides transparency to the manufacturer 102 regarding how sales of the promotional item are affected by the promotion without the manufacturer 102 having to collect and analyze data from multiple retailers 106.

The retailer 106 uses the sales and relationship information to, for example, monitor how the sales associates 108 are performing. For instance, managers at the retailer 106 can use the sales and relationship information provided by the promotion server 202 to identify high and/or low performing sales associates 108 for promotions/layoffs. The retailer 106 may also use the information provided by the promotion server 202 to compare how their sales associates 108 compare to sales associates at other locations and/or retailers.

Further, the sales associates 108 use the sales and relationship information to monitor how many promotional items they have each sold and how they rank against each other. The promotion server 202 accordingly transforms a promotion into an active competition among sales associates 108 in which they monitor their progress/rank in real-time from any device. As a result, the promotion server 202 provides a framework for better informing and incentivizing sales associates 108 regarding promotions.

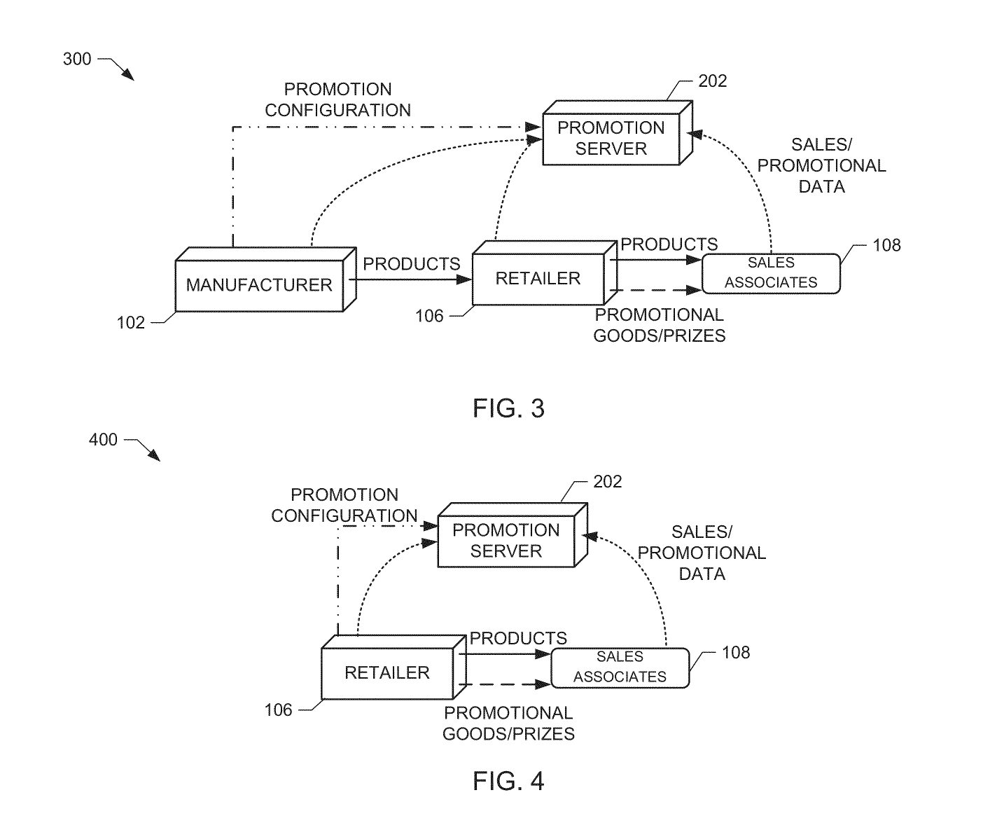

FIG. 3 is a diagram of a promotional environment 300. In this illustrated example, the manufacturer 102 provides products directly to the retailer 106. It should be noted that this promotional environment 300 does not include a distributor 104 or the promotion agency 110. The retailer 106 may be responsible for distributing the products to different retail locations. For instance, the manufacturer 102 produces computers and the retailer 106 is a big-box store that sells the computers. In this instance, the promotion server 202 provides visibility to the manufacturer 102 regarding how computer sales are affected by a promotion at the retailer 106.

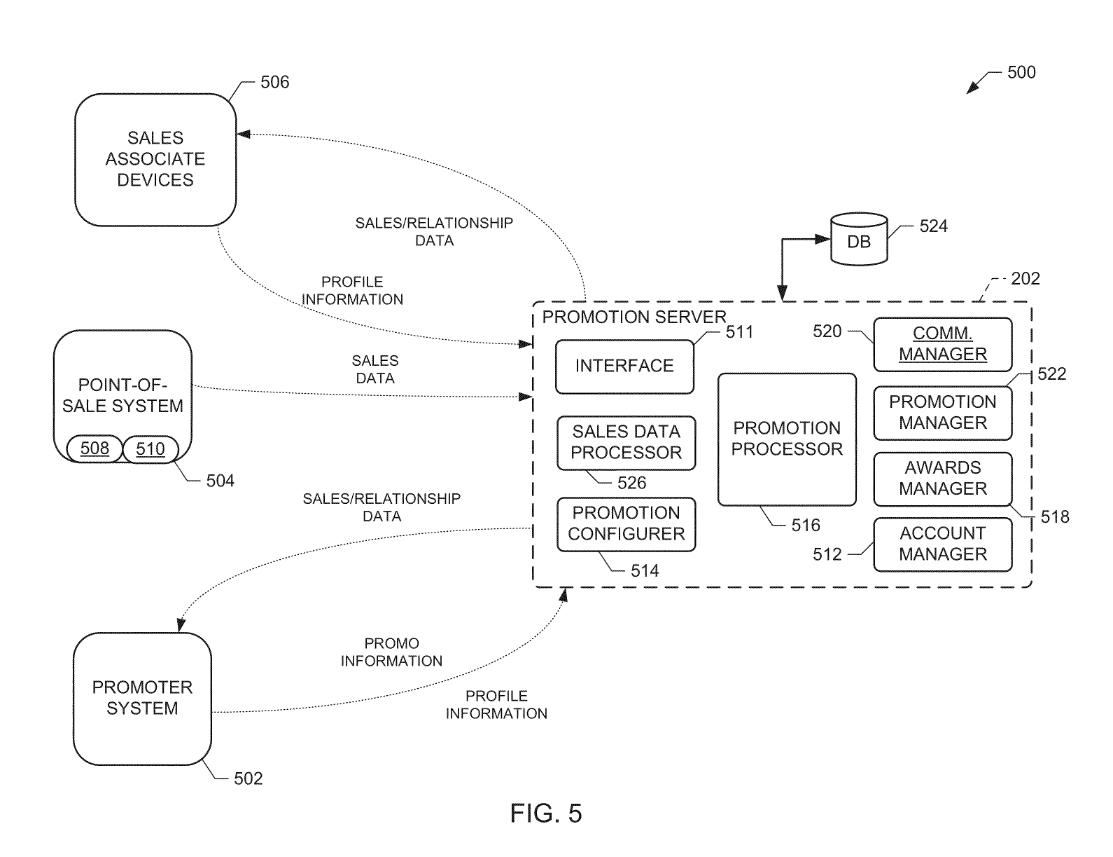

FIG. 4 is a diagram of a promotional environment 400 that only includes a retailer 106. In this example, the retailer 106 may be a large organization that has multiple retail locations (e.g., retail outlets). The example promotion server 202 enables the retailer 106 to efficiently and effectively manage promotions across the different locations. The example promotion server 202 also provides a cost effective solution to enable the retailer 106 to directly correlate promotions to sales of promotional items.

### Promotional Environment Functional Embodiment

FIG. 5 shows an example functional diagram 500 including the promotion server 202 of FIGS. 2 to 4. The illustrated promotion server 202 is communicatively coupled to a promoter system 502, a point-of-sale system 504, and sales associate devices 506 via any wired and/or wireless communication medium (e.g., the Internet, wireless local area network, wide area network, etc.). It should be appreciated that the diagram 500 shown in FIG. 5 is only one example of implementing the promotion server 202. In other embodiments, the functional blocks may be combined, removed, rearranged or expanded. For instance, the promotion server 202 may additionally include a data mining component and/or a report generation component. Further, while the functional diagram 500 shows only one promoter system 502 and point-of-sale system 504, it should be appreciated that in other embodiments the promotion server 202 is communicatively coupled to a plurality of systems 502 and 504 operated by different entities.

### Promoter System

The example promoter system 502 of FIG. 5 includes any computer, network, server, processor etc. that is operated by a promoter (e.g., the manufacturer 102, the distributor 104, the retailer 106, and/or the promotion agency 110). As discussed in more detail below, the promoter system 502 provides promotion information, which is used by the promotion server 202 to configure and host a promotion. The promoter system 502 may also provide profile information, which is used by the promotion server 202 to create a dashboard or homepage for a promoter to centrally manage all associated promotions. The promoter system 502 is further configured to receive (or access) sales and/or relationship data associated with promotions, which is made available by the promotion server 202.

### Point-of-Sale System

The example point-of-sale system 504 includes one or more point-of-sale terminals 508 (e.g., cash registers), which are used by sales associates to process transactions related to the sale of products/services. The point-of-sale terminals 508 are configured to record to a data structure information associated with a transaction. This information includes, for example, an identifier of a product/service sold, a quantity of each product/service sold, a date/time of a sale, an identifier of a retailer/location, an identifier of a sales associate, etc. The point-of-sale terminals 508 may be configured to create a data structure for each transaction. Alternatively, the point-of-sale terminals 508 may be configured to create a data structure for all transactions within a time period (e.g., a sales shift).

The terminals 508 may be configured to parse promotional item sale data from a complete transaction such that only the sale of the promotional data is stored to a data structure. Alternatively, the terminals 508 may include all sales information including non-promotional items included in the transaction. The example point-of-sale terminals 508 transmit information included within the data structures to a point-of-sale server 510.

In some instances, point-of-sale terminals 508 transmit the information of the data structures after the completion of a transaction. Alternatively, the information of the data structures is transmitted at the end of a time period (e.g., a sales shift, day, etc.). The point-of-sale server 510 may be centrally located and receive information of the data structures from point-of sales terminals 508 within a single retail location and/or from point-of-sales terminals 508 from multiple locations of a retailer. For instance, the point-of-sale system 504 may include a point-of-sale server 510 for each retail location or a centrally located point-of-sale server.

The point-of-sale server 510 compiles the data structures for transmission to the promotion server 202. The point-of-sale server 510 may filter the data structures for transactions that include promotional items (e.g., in instances where promotional sales data is included within non-promotional sales data). Alternatively, the point-of-sales terminals 508 may be configured to only transmit transaction information of data structures that include promotional items. For example, the promotion server 202 could provide identifiers of promotional items to the point-of-sale system 504. The identifiers may be an industry-code (e.g., a stock keeping unit (“SKU”) used by the promoter system 502 to label/classify products/services. The point-of-sale system 504 propagates the promotional item identifiers to the appropriate point-of-sale terminals 508 and/or point-of-sale servers 510. For instance, only some geographic locations of a point-of-sale system 504 may be included within a promotion. The point-of-sale terminals 508 and/or point-of-sale servers 510 use the promotional item identifiers to determine which transactions (or data structures indicative of transactions) are to be provided to the promotion server 202.

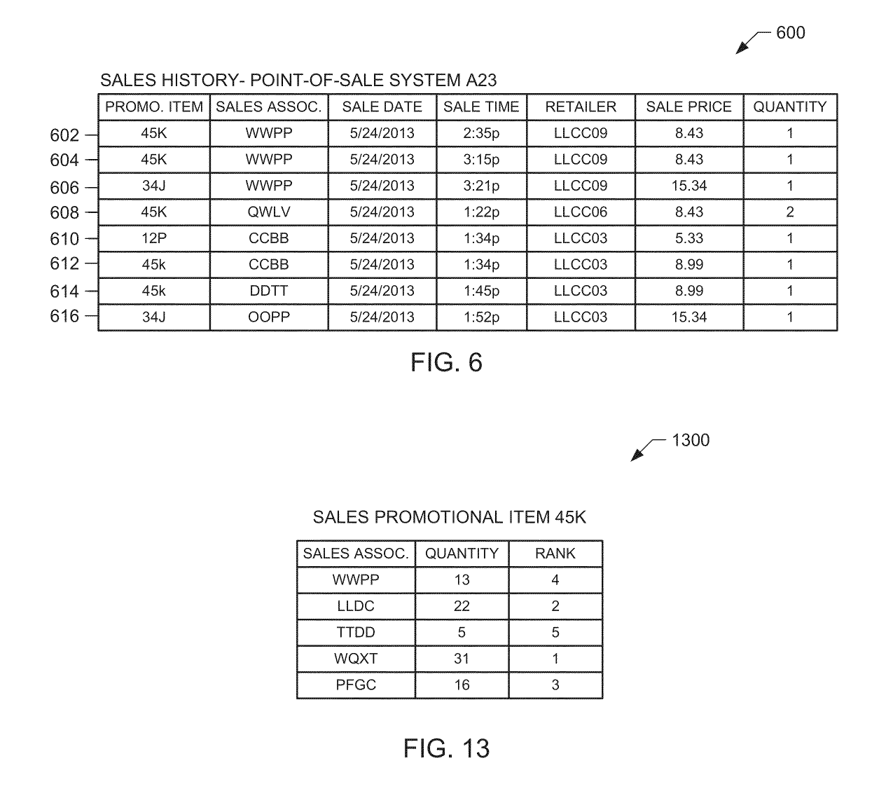

For example, FIG. 6 shows a diagram of an example data structure 600 compiled by a point-of-sale server 510 using promotional item identifiers. The data structure 600 includes data structures 602 to 616 that are indicative of transactions (e.g., sales data) recorded by point-of-sale terminals 508. The promotional items are identified by identifiers ‘45K’, ‘34J’, and ‘12P’, which correspond to promotional items specified by the promotion system 502. For example, 45K and 12P could correspond to two different drink specials that includes a liquor that is manufactured by a manufacturer (or distributor, promotion agency, retailer, etc.) associated with the promotion system 502 and ‘34J’ could correspond to a food special that is provided by a second promotion system (not shown).

The data structure 600 also includes fields for an identifier of a sales associate, a sale date/time, retailer, sale price, and quantity. The different retailer identifiers indicate different retail locations owned (or licensed by) the same retailer. It should be noted that the same promotional item, (e.g., 45K) was sold by different sales associates at different retail locations for different sales prices. The example promoter system 502 could accordingly configure a promotion by specifying different prices for a promotional item based on geographic region (e.g., New York City, Texas, Pacific Northwest, etc.).

As described in more detail below, the promotion server 202 is configured to use an application programmable interface (“API”) or a file transfer protocol (“FTP”) to access the data structure 600 stored at the point-of-sale servers 510. For example, the promotion server 202 may access the point-of-sale servers 510 at period times (e.g., every ten minutes, hourly, daily, etc.) to download the most recent sales data. The promotion server 202 may also be configured to monitor the point-of-sale servers 510 or point-of-sale terminals 508 to detect a transaction that includes a promotional item. Responsive to detecting the transaction, the promotion server 202 causes the point-of-sale servers 510 or point-of-sale terminals 508 to provide the appropriate data structure that includes sales data indicative of the sale of the promotional item. Alternatively, the promotion server 202 accesses the point-of-sale servers 510 or point-of-sale terminals 508 to acquire promotional item sales data or substantially all transaction data. Regardless of the specific method used, the promotion server 202 acquires information included within data structures associated with sales transactions.

Additionally or alternatively, the point-of-sale servers 510, the point-of-sale terminals 508, and/or the point-of-sale system 504 may be configured to transmit the information included within the data structure 600 or separately transmit the information of data structures 602 to 616. These components may transmit the information of the data structures periodically (e.g., every ten minutes, hourly, daily, etc.) or after every time a data structure is created and/or updated.

### Sales Associate Devices

The promotion server 202 of FIG. 5 is also communicatively coupled to sales associate devices 506, which are associated with sales associates 108. These devices 506 provide sales associates 108 with access to sales data associated with promotions hosted by the promotion server 202. For instance, a sales associate can use device 506 to view a quantity of sales for subscribed or registered promotions, a ranking among other sales associates for each promotion, a cumulative ranking among other sales associates based on previous and/or current promotions, information describing current and/or future promotions, and/or accumulated awards (e.g., virtual currency, virtual badge, level, indication of physical award, etc.).

The sales associates 108 also use the devices 506 to provide profile information. As described in more detail below, the profile information includes account set-up information and work information. The promotion server 202 uses this information in conjunction with the promotion sales data to provide a profile page for each sales associate 108. The devices 506 can include any computer, laptop, processor, server, smartphone, tablet computer, etc.

### Promotion Server

The example promotion server 202 of FIG. 5 is configured to provide a hosted framework (e.g., website, application, etc.) for providing promotional sales data to promoters and sales associates. The promotion server 202 may be implemented as a single server. Alternatively, functionality of the promotion server 202 may be distributed among multiple servers and/or within a cloud computing environment. As disclosed below in more detail, the promotion server 202 includes at least the following functionality: i) promoter profile management, ii) sales associate profile management, iii) promotion creation, iv) promotion management, v) award determination, and vi) communication.

It should be appreciated that the promotion server 202 includes an interface 511 to receive and transmit information between sales associate devices 506, point-of-sale systems 502, and/or promoter systems 502. The example interface 511 may be configured to operate using web-based interfaces and/or application interfaces. For instance, the promotion server 202 may host promotions and provide profile management through web pages, which can be configured for sales associates, and promoters. In these examples, the interface 511 provides a gateway to the web pages. This gateway may include account and/or security features to ensure that only authorized associates and promoters have access to the appropriate pages.

Additionally or alternatively, the promotion server 202 may provide one or more applications (e.g., apps) that are downloadable to sales associate devices 506 and/or the promoter system 502. These applications may pull (e.g., subscribe) or receive data from the promotion server 202 and be configured to display promotion sales and profile data in an appropriate interface. In these embodiments, the interface 511 is configured to function as an API that provides the appropriate data to the appropriate devices.

The example interface 511 may also be configured to receive and transmit information to the point-of-sale system 504. For instance, the interface 511 may be configured to transmit information identifying promotional items. The example interface 511 may also be configured to receive (or access) information stored to data structures (e.g., the data structure 600) from the system 504, servers 510, and/or terminals 508.

### i) Promoter Profile Management

The example promotion server 202 of FIG. 5 is configured to enable promoters to manage multiple promotions through a hosted service. The promotion server 202 includes an account manager 512, which is configured to manage account information of promoters and sales associates. To efficiently manage multiple promotions, the account manager 512 prompts promoters to create a profile, which includes account management information and general information. The account management information includes, for example, a business address, telephone number, billing information, a user account name, authorized administrators, and any other relevant information. The general information includes company information and a description of products produced or sold by the promoter. The general information may be targeted to sales associates as a way of informing them about the promoter.

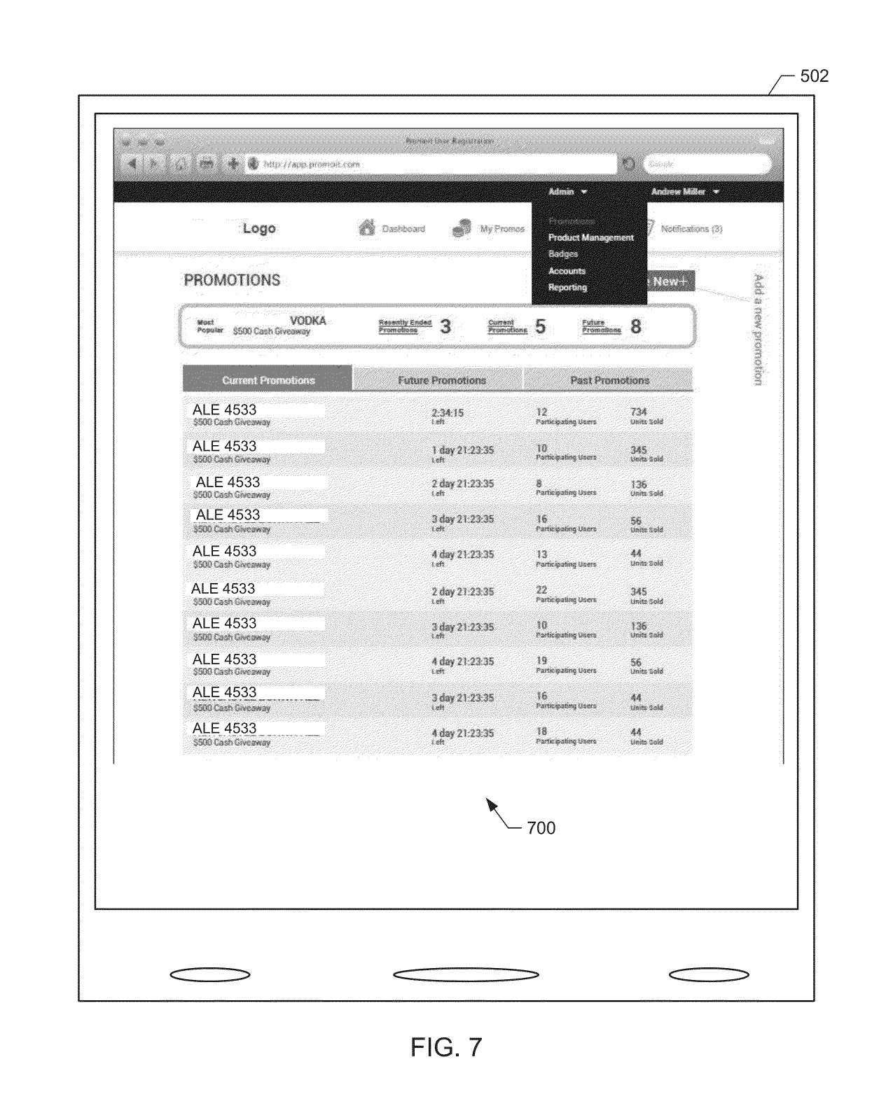

The example account manager 512 uses the information provided by the promoters to create a profile page. In some embodiments, the account manager 512 uses one or more templates to format the profile information into a promoter-specific centralized homepage or dashboard. The profile page includes summarized information for all promotions created by the promoter and links to more detailed information for each promotion. For example, FIG. 7 shows a diagram of an example profile page 700 created by the account manager 512 for a promoter. The profile page 700 includes listings of current, future, and past promotions for the promoter. For current promotions, the account manager 512 includes the most recent sales data for each promotion including a quantity of participating sales associates, a quantity of promotional items sold, and a time remaining for each of the promotions.

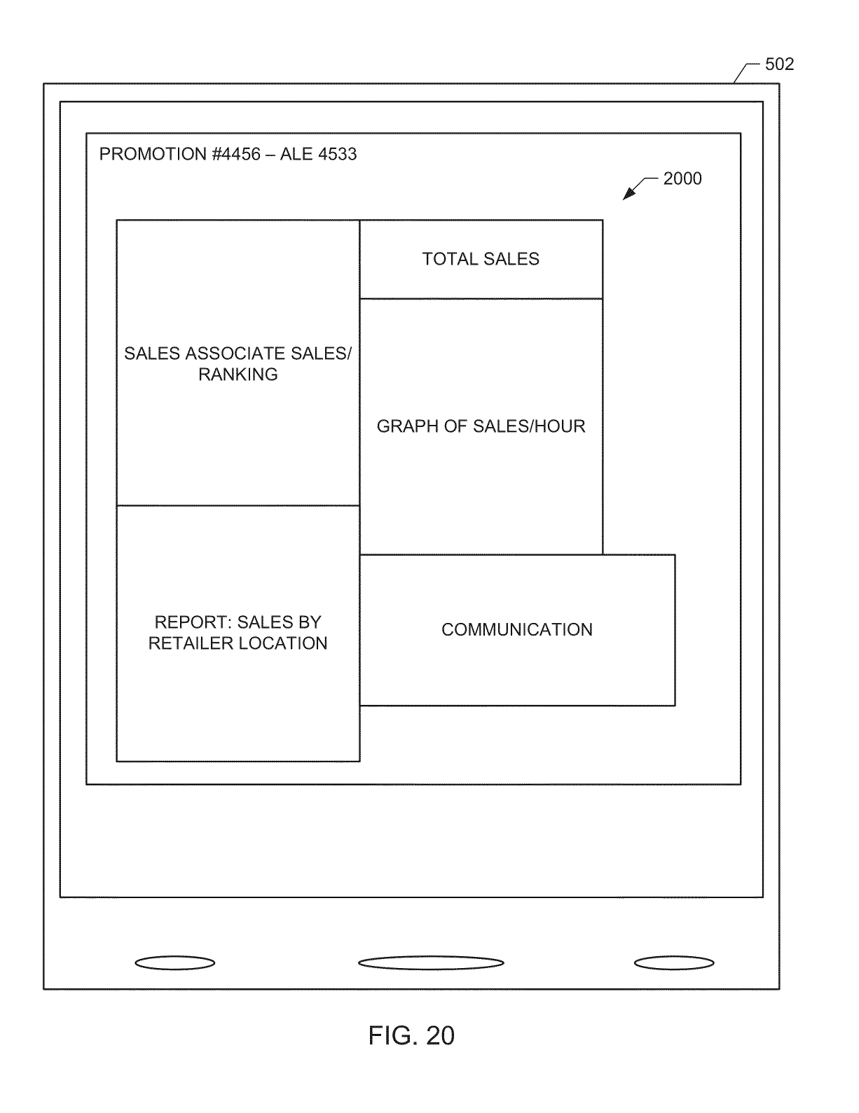

A promoter may select any one of the listed promotions to view more information associated with the promotion including a ranked listing of the sales associates participating in the promotion. FIG. 20 shows a diagram of a promotion web page 2000 that is accessed by the promoter by selecting one of the listed promotions in FIG. 7. The web page 2000 is configured by the promotion server 202 specifically for the promoter. As described in more detail below, a promoter can specify to the account manager 512 which types of promotional information is to be displayed within the web page 2000. In this illustrated example, the information includes a total quantity of sales of a promotional item, a ranking of sales associates, and analytic information of a quantity of sales per hour during the promotional time period. The web page 2000 also includes a report requested by the promoter of retailer sales by location. The web page 2000 further includes communication functionality that enables the promoter to post or transmit messages to the sales associates participating in the promotion.

### ii) Sales Associate Profile Management

The example account manager 512 of FIG. 5 is also configured to provide account management for sales associates 108. Similar to the profile pages for promoters, the account manager 512 uses the sales associate profile pages as a centralized homepage or dashboard for providing profile information and information regarding past, current, and future promotions to the sales associates. The profile pages also provide a virtual address for receiving awards.

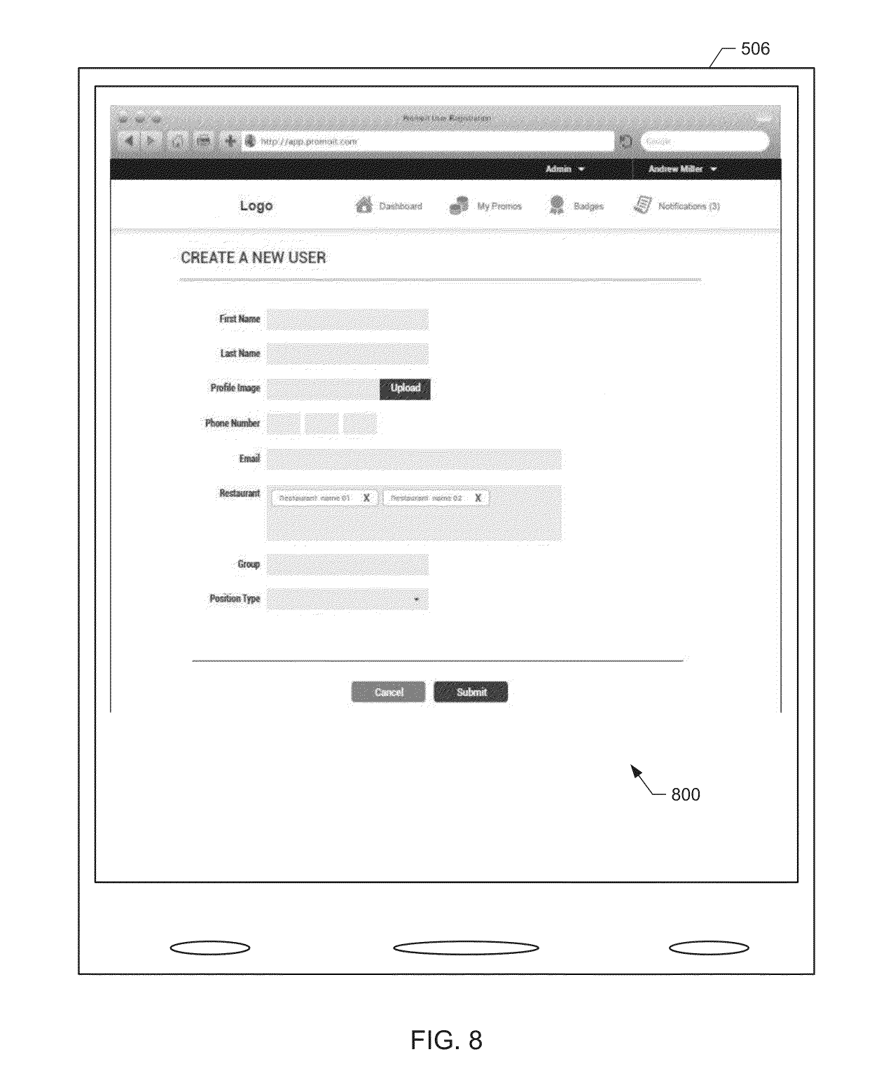

FIG. 8 shows a diagram of an example registration web page 800 (or form) provided by the account manager 512 to sales associates 108 at a time when an account is initially configured. The registration page 800 includes a name of the sales associate, a profile picture, a phone number, an e-mail address, employers (e.g., retailers), a work group, and a position type. In other embodiments, the registration page 800 can include fields that enable the sales associate to specify which types of promotions they would like to receive an invitation, prize/award preference, and/or alert notifications (e.g., an indication for the promotion server 202 to send their device 506 an alert when they win a promotion, are within a certain sales quantity of receiving an award, etc.). The registration page 800 may also include a field for a sale associate identifier, which is included within sales transactional data.

It should be appreciated that the promotion server 202 uses at least some of the information provided by the sale associates through the registration page 800 to determine which associates should receive a notification regarding a promotion and/or which sales associates are authorized to participate in a promotion. For example, the employer field can be used to select sales associates associated with particular retailers and/or retail locations.

In some embodiments, the account manager 512 may operate in conjunction with one or more social media websites to receive sales associate information. For example, the promotion server 202 may have an agreement with Facebook® that enables the account manager 512 to receive profile information (e.g., name, profile picture, etc.) for a sale associate though that person's Facebook account. The account manager 512 may also be configured to function as an interface with social media websites by providing information that could be broadcast though the social media service (e.g., a notification that a sales associate received an award).

iii) Promotion Creation

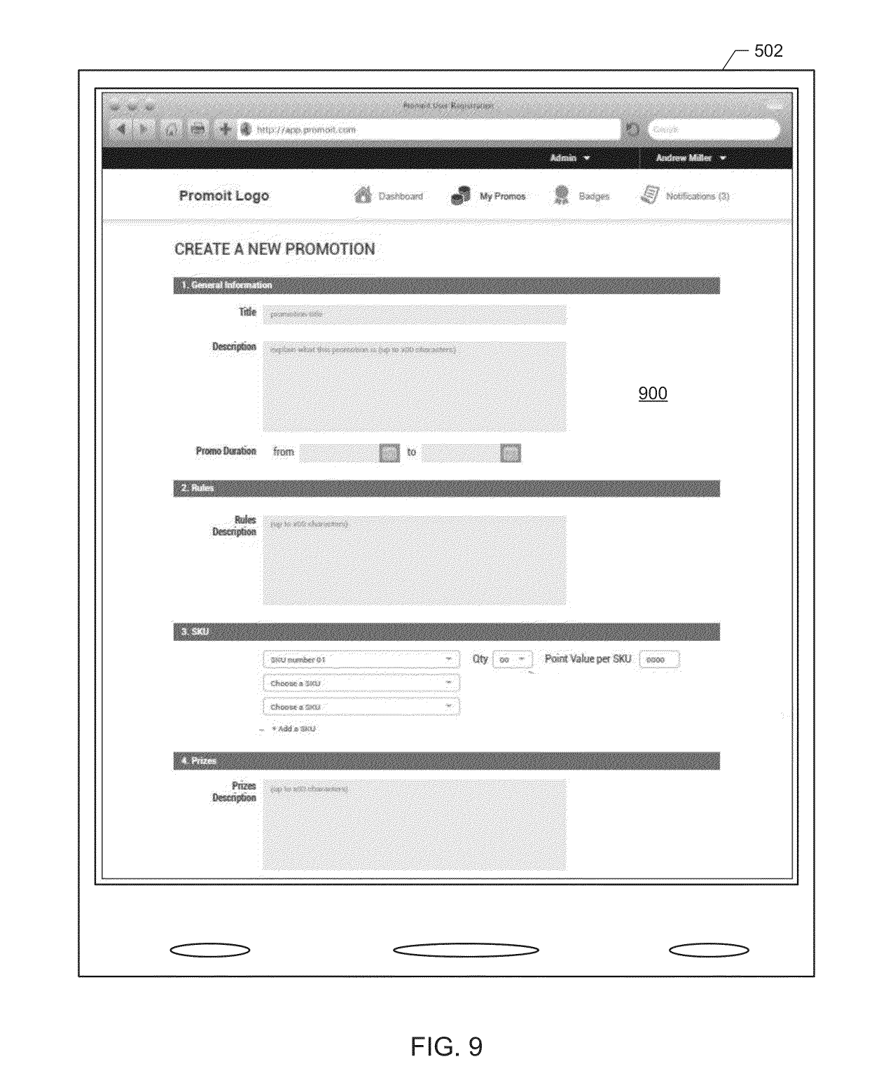

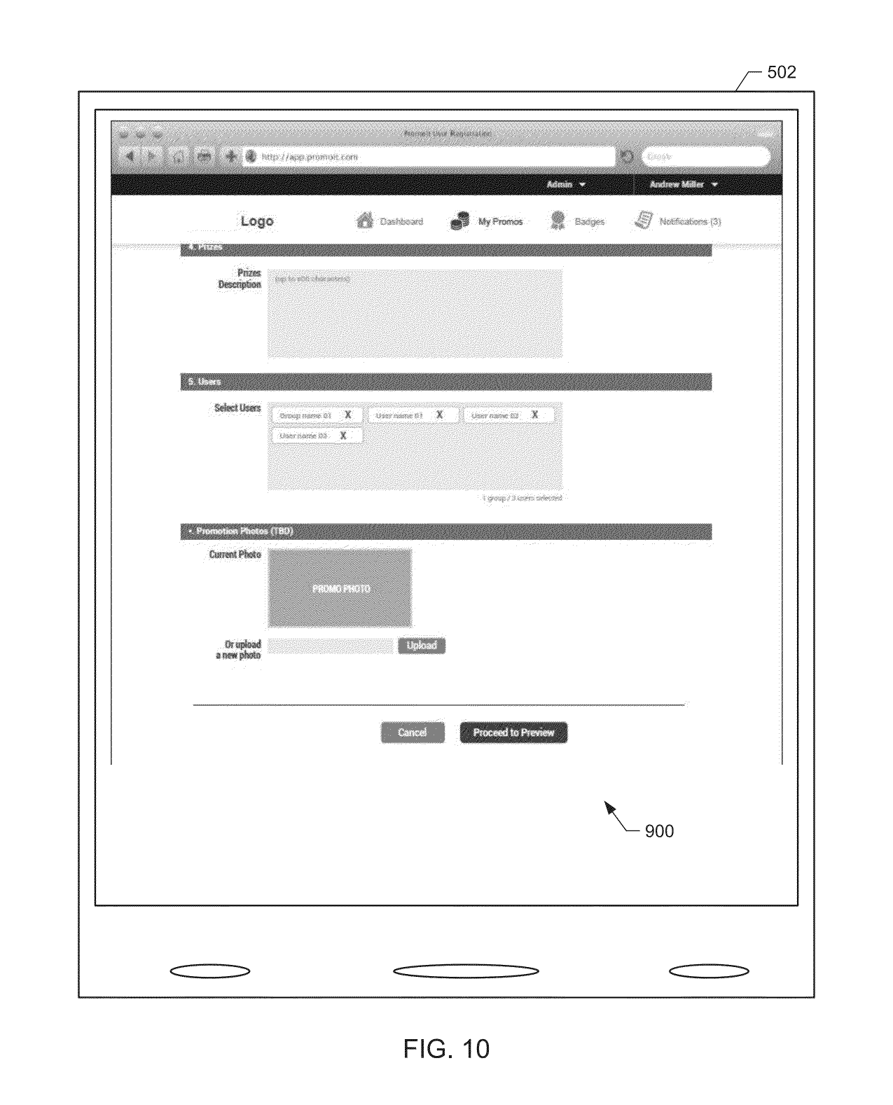

The example promotion server 202 of FIG. 5 includes a promotion configurer 514 to manage the creation of promotions. The example promotion configurer 514 is configured to prompt promoters for promotion information in response to receiving a request to create a promotion. For example, the promotion system 502 may access the promotion server 202 and select (via a corresponding profile page) to create a promotion. Responsive to this request, the promotion configurer 514 provides one or more fields in a promotion registration web page (or app) that are to be completed before a promotion can be created. FIGS. 9 and 10 show diagrams of an example promotion registration web page 900 displayed by promoter system 502. The web page 900 includes data fields for a promotion title, a promotion description, a promotion duration (e.g., time period), a rules description, identifiers of promotional items, a description of prizes, sales associates or groups of sales associates to invite, and a promotional photo/video.

The rules description is shown as a text field. A promoter may provide natural language rules for display on a web page associated with the promotion. In some embodiments, the registration web page 900 of FIGS. 9 and 10 may also include one or more fields for a promoter to define award rules for the promotion server 202. For instance, a promoter may select a ranking (e.g., the sales associate with the most sales) and a corresponding award (e.g., $500).

A promoter may also provide sub-time periods during a promotional period in which awards are provided. For example, a promoter may specify that an award is to be provided half-way through a promotion. Additionally or alternatively, a promoter may specify time periods in which a weighting is applied to sales (e.g., a drink sale is worth 1.5 sales during happy hours). It should be appreciated that the amount of types of rules that could be provided by promoters is almost limitless.

The promotion configurer 514 may also enable a promoter to provide additional rules for a promotion. For example, a promoter may enable sales associates to have weighted sales based on previous promotional campaigns in which they have participated. For example, sales weights could be based on a sales level, which is determined based on participation or results of previous promotions. For instance, a promotion manager 522 may increase the level of a sales associate after the sales associate has participated in a threshold quantity of promotions and/or sold a threshold quantity of promotional items. The sales weight of the sales associate accordingly increases as the level or ranking increases.

These types of incentive awards or levels reward sales associates who consistently outperform peers. However, providing weights based on experience or previous promotions may discourage relatively new sales associates from participating. In some of these instances, the promotion configurer 514 may provide an option on the web page 900 of FIGS. 9 and 10 for a promoter to provide awards based on sales associates with relatively the same experience. For example, all sales associates with levels between 0 and 3 are ranked together while sales associates levels between 4 and 6 are ranked together. This increases competition among sales associates with the same experience.

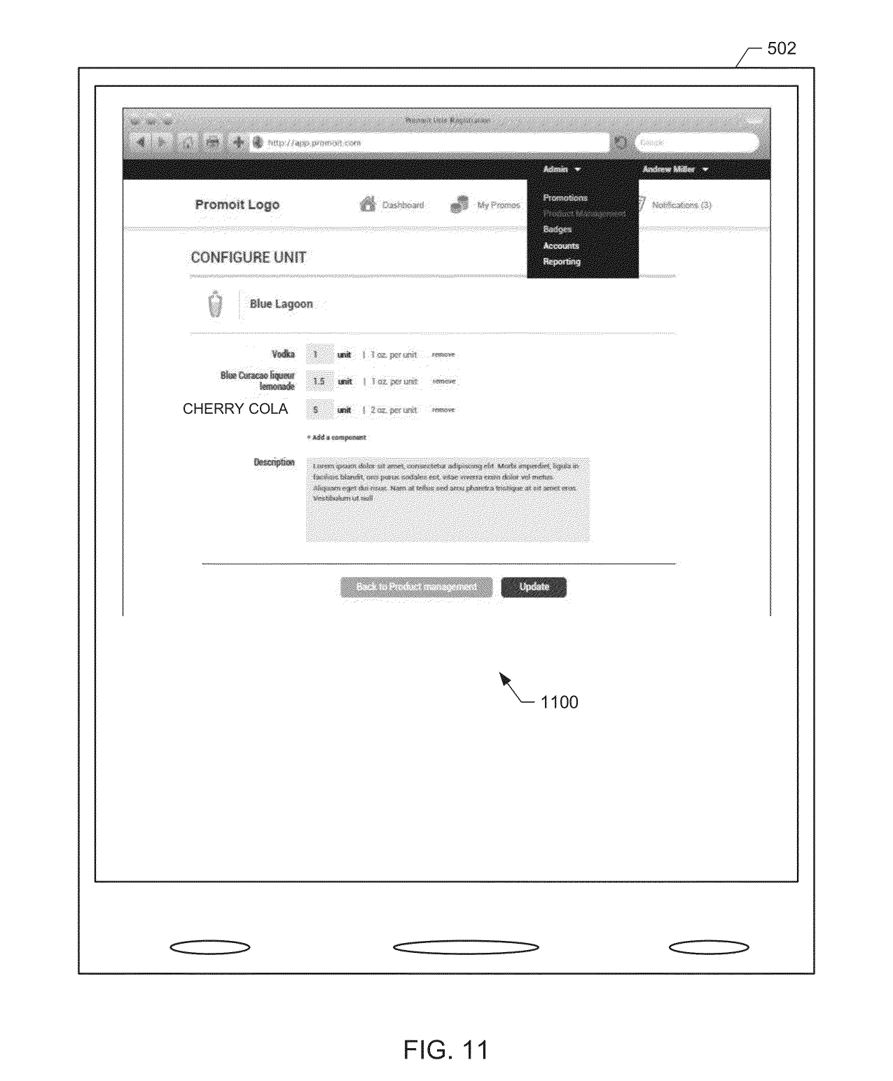

In addition to providing information regarding a promotion, the promotion configurer 514 is also configured to enable promoters to configure a promotional item for the promotion. This feature may be especially useful for drink or food specials, where the sales associates 108 are tasked with creating the promotional item from base beverages or ingredients. For example, FIG. 11 shows a diagram of a web page 1100 provided by the promotion configurer 514 to enable a promoter to specify a drink special as a promotional item. In this illustrated example, the web page 1100 includes a name of the promotional item (e.g., ‘Blue Lagoon’), a composition of the promotional item (e.g., 1 unit Absolute® Vodka, 1.5 units of Blue Curacao, and 5 units of Cherry cola), and a description of the promotional item.

The example promotion configurer 514 uses the promotional item configuration information provided in web page 1100 in conjunction with the promotion information provided in web page 900 to create or provision a promotion web page. In some instances, the promotion configurer 514 uses the received information to configure rules or other aspects of the promotion. The promotion configurer 514 may also transmit the configuration information to the point-of-sale system 504 to add the promotional item to a list of available products for sale.

In addition to prompting promoters to specify aspects or parameters of a promotion, the example promotion configurer 514 of the promotion server 202 is configured to create promotions. To create a promotion, the promotion configurer 514 analyzes the information provided by the promoter in the web page 900 of FIGS. 9 and 10 (and the web page 1100 of FIG. 11 where applicable). The promotion configurer 514 then executes one or more routines to automatically generate a web page (or application) for the promotion.

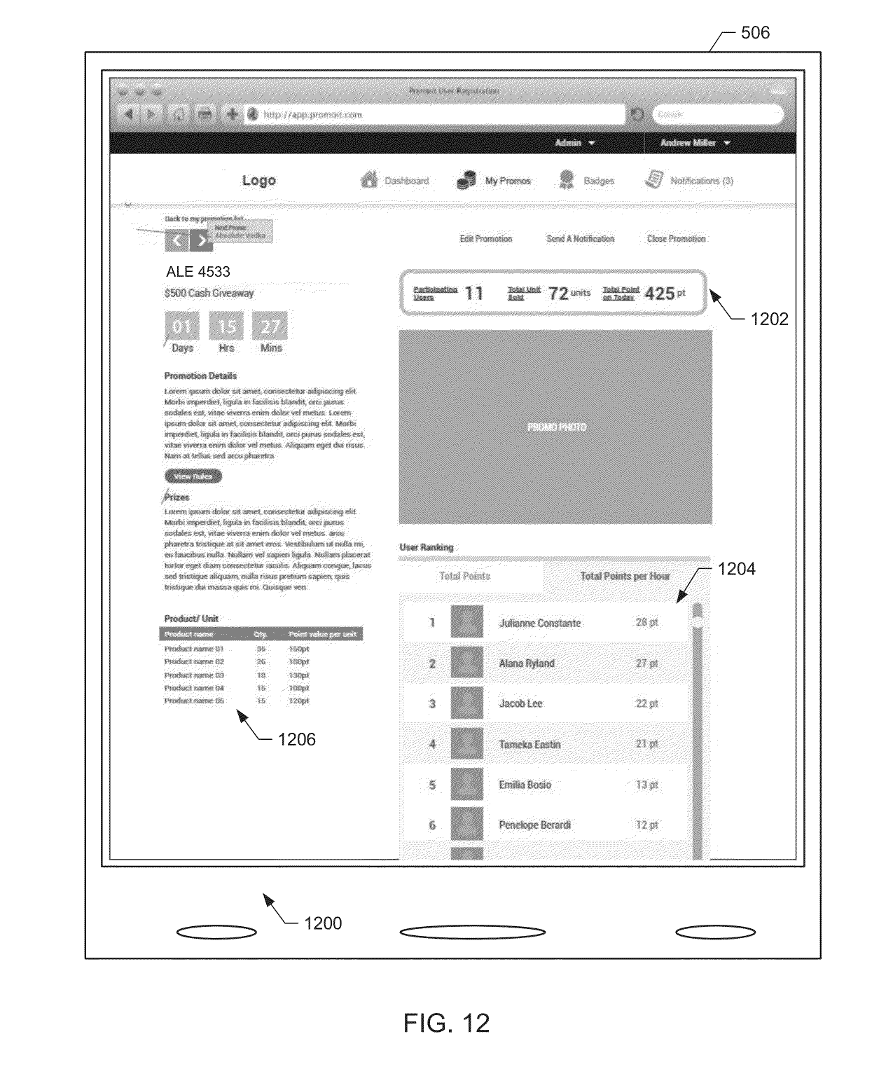

FIG. 12 shows a diagram of an example promotion web page 1200 that is created by the promotion configurer 514. The web page 1200 includes the information provided by the promoter in a template-based format. The example promotion configurer 514 uses the information provided in the fields in web page 900 populated by the promoter as text within the web page 1200.

The promotion configurer 514 uses the promotion information shown in FIGS. 8 and 9 to create the one or more pages 1200 of FIG. 12 for a promotion. As a result, a promoter can quickly provide uniform and consistent information to a relatively large and distributed group of sales associates regarding the rules and description of a promotion. This enables the sales associates to be relatively well informed, to the extent they check their devices 506 regarding promotions. Such an automatic dissemination of promotion information is more efficient and effective compared to relaying information to retailers (or promotion agencies), which then distribute the information to sales manages, which then inform sales associates.

It should be appreciated that a promoter can provide the information shown in FIGS. 9 and 10 in a relatively short time period. This enables a promoter to quickly launch a promotion within a matter of minutes, instead of within days to weeks using known promotional environments. A promoter can accordingly provide a promotion quickly in response to social or entertainment trends or current events. For example, a promoter could operate a consolation promotion in a first geographic location in response to a first hockey team losing a contest and simultaneously operate a championship promotion in a second geographic location in response to a second hockey team winning a contest within minutes of the contest ending.

The example promotion configurer 514 is configured to provide the promotion web page 1200 to the intended audiences (e.g., the sales associates 108 and the promoter). In some instances, the promotion configurer 514 may provide the web page 1200 before a promotion as a preview. Then, responsive to detecting the start of the specified promotional period, the promotion configurer 514 activates functionality of the promotion web page 1200 by showing, for example, sale associate rankings, a quantity of promotional items sold, and a time remaining.

In some embodiments, the promotion configurer 514 is configured to create a promoter-based promotion web page and a sales associate-based promotion web page. The promotion configurer 514 may also be configured to create retailer or third-party-based promotion web pages. In these embodiments, the different types of web pages are separate and distinct from each other in the amounts and types of information presented. For instance, the sales associate-based page may include more promotional item advertising, award information, and relatively streamlined information regarding promotional item sales (e.g., a ranking and a quantity of sales for the respective sales associate).

In contrast, the promoter-based page may include less information regarding the promotional item and more information regarding sales including, for example, more detailed sales information for different retail locations, different retailers, different time periods (e.g., a bar graph of sales/hour during the promotional period), different groups of sales associates, etc. Further, the retailer-based page may include promotional item information and sales data associated with each retailer. The promoter-based page may also be configured to enable a provider to compare promotional sales between different franchisees, retailers, retail locations, geographic locations, etc.

The example promotion server 202 of FIG. 5 is also configured to either include functionality for promoters to provide coded rules or include functionality that parses natural language to configure rules for provisioning a promotion. For instance, a promotion processor 516 could be configured to create programmed rules for determining when to provide an award based on natural language rules provided by a promoter. A promoter may provide the phrases “$250 to the top three sellers! T-shirts to the next three sellers!” in the rules field of web page 900. The promotion processor 516 pareses these phrases and creates a first programmed rule that specifies the top three ranked sales associated at the end of the promotional period are each awarded an item identifier corresponding to $250 and creates a second programmed rule that specifies sales associated ranked fourth through sixth are each awarded an item identifier corresponding to the T-shirt. These programmed rules enable an awards manager 518 to accordingly automatically distribute awards to sales associates at the designed time periods.

After creating a promotion web page, a communication manager 520 is configured to transmit messages informing (or inviting) sales associates regarding the promotion. The communication manager 520 may be provided, by the promotion configurer 514, identifiers of sales associates (and/or retailers/retail locations) selected by the promoter. The promotion configurer 514 also provides the communication manager 520 a link or web address to the promotion web page(s). In response to receiving this information, the communication manager 520 transmits, for example, e-mail messages, text messages, or internal messages posted to profile or promotion pages of sales associates. The messages include information regarding the promotion and/or a link to the corresponding promotion web page 1200. The messages may also include an invite for the sales associate to register or subscribe to the promotion.

After creating a promotion, the example promotion configurer 514 may enable a promoter to modify or delete the promotion. For example, a particular promotion may be more successful than anticipated. As a result of this success, a promoter may desire to extend the duration of the promotion. A promoter accordingly uses the promotion system 502 to access the promoter's dashboard or homepage, which includes an option to modify current promotions. Responsive to receiving a selection of a promotion to modify, the promotion configurer 514 provides the promotion system 502 with the web page 900 including the previously provided information. A promoter can modify the information in the web page 900, causing the promotion configurer 514 to update the promotion web page 1200. As a result of this configuration, a promoter can relatively easily extend a promotional period, change awards, provide additional promotional information, etc.

### iv) Promotion Management

After a promotion has been created, the example promotion manager 524 of FIG. 5 is configured to operate or provide for the hosting of the promotion. As described above, the promotion configurer 514 creates promotion web pages (or applications, instances of an application, etc.) based on promotion information provided by promoters. The promotion configurer 514 may also store the created promotion web pages to a database 524. The promotion manager 524 causes the stored promotion web pages to be made available or hosted for sales associates, promoters, retailers, etc. The promotion manager 524 also modifies the content shown on the promotion pages based on sales data for the corresponding promotional item.

To process sales data, the example promotion server 202 includes a sales data processor 526. The example sales data processor 526 is configured to receive or acquire information stored in data structures (e.g., the data structure 600 of FIG. 6) from point-of-sale systems 504. The sales data processor 526 is configured to sort and parse the data structures based on one or more routines to extract promotional sales data. The sale data processor 526 sorts data so that transactions that include the same promotional item are stored to in the same location. The sales data processor 526 also sorts data by sales associate identifier, retailer identifier, date/time, etc. The sale data processor 526 may further remove transactions or data that corresponds to the sale of non-promotional items or sales associates not associated with a promotion. The sales data processor 526 stores the sorted and filtered information included within the data structures as promotional data to the database 524. The example database 524 may be implemented by any computer-readable medium, including RAM, ROM, flash memory, magnetic or optical disks, optical memory, or other storage media.

In an example, the sales data processor 526 parses data structures 602, 604, 608, 612, and 614, which all correspond to the promotional item ‘45K’. The sales data processor 526 then stores these data structures 602, 604, 608, 612, and 614 to a separate data structure specifically for promotional item ‘45K’. The sales data processor 526 then sorts the ‘45K’ information within the data structure by retailer, sales associate, and date/time. This parsing and sorting enables the promotion processor 516 and the promotion manager 522 to relatively quickly access promotional data.

The example promotion manager 522 of FIG. 5 is configured to analyze the sorted and filtered promotional information and determine a quantity of sales of the promotional item for each sales associate. The promotion manager 522 may be configured to determine the quantity of sales responsive to detecting that data has been received and processed by the sales data processor 526. Alternatively, the promotion manager 522 may be configured to determine the quantity of sales at periodic times (e.g., hourly).

The promotion manager 522 stores to a data structure (e.g., the data structure 1300 shown in the diagram of FIG. 13) the quantity of sales of a promotional item for each sales associate. The personal promotion pages of the sales associates may include a link to the appropriate field within the data structure 1300 such that the personal pages are updated as new quantities are calculated. Additionally, web pages associated with the promoter may be linked to the data structure 1300 or include scripts to access data stored in the data structure 1300.

In addition to determining a quantity of sales, the promotion manager 522 is configured to determine relationships among the sales associates associated with a promotion and perform analytics on the sales quantities. Determining relationships may include, for example, determining a ranking of the sales associates based on a total quantity of promotional items sold, as shown in the data structure 1300 of FIG. 13. Determining relationships may also include determining which sales associates have sold more of the promotional items within a time period (e.g., the previous 10 hours) as a way of providing trends among the sales associates. Determining relationships may also include applying sale weights and determining ranks based on weighted sales based on, for example, a time a promotional item was sold, a level of a sales associate, etc.

Responsive to determining relationships, the promotion manager 522 provides information indicative of the relationships to the sales associates 108 and/or the promoters. To provide information indicative of the relationships, the promotion manager 522 may create a data structure that includes the relationships. Scripts operating on the promotion or profile pages of the promoters and sales associates are configured to access information included within the relationship data structure to display the contents to the web pages (or in an application).

The example promotion manager 522 performs analytics on the promotional information to determine, for example, sales for different time periods, sales over a time period (e.g., sales/hour), sales for particular geographic locations/retailers, etc. The promotion manager 522 stores the results of the analytics to the database 524. The promotion manager 522 may also provide the analyzed data to the appropriate promoters and/or sales associates by setting permissions for the stored data. For instance, the promotion manager 522 may specify that some analyzed data is viewable only by a promoter system 502. The permissions maybe pre-specified based on analyzed data type so that the promotion manager 522 provides the same types of permissions for different promotional item information (e.g., all sales history data and retailer data is to be viewable only by a promoter).

In some instances, the promotion processor 516 may provide the analyzed data on a promotion or profile page of a promoter and/or sales associate based on the permissions. For example, some templates may include locations for analyzed data. In some embodiments, the promoters may select which types of analyzed data are to be provided. In other instances, the promoter system 502 and/or the sales associate device 506 may have to provide a request to view analyzed data.

FIGS. 12, 14, and 15 show diagrams of example web pages 1200, 1400, and 1500 displaying data processed and stored by the promotion manager 522. For example, the web page 1200, as discussed above, is a promotional web page viewable by a sales associate. In addition to providing information regarding the promotion, the web page includes scripts or links to sales data. For instance, a status field 1202 receives information regarding how a sales associate compares to peers for a promotion. This includes a total quantity of participating sales associates, a quantity of promotional items sold by the sales associate, and a total quantity of points (e.g., weighted sales) accumulated by the sales associate based on the sales.

The web page 1200 also includes a ranking field 1204, which is linked or accesses information from the data structure 1300 of FIG. 13. The ranking field 1204 provides a real-time update as to the relationship (e.g., ranking) of the sales associate compared to other peer sales associates for the promotion. In other embodiments, the web page 1200 could also include data fields to provide a chart showing the sales associate sales/day or sales/hour.

It should be noted that the web page 1200 also includes a multiple item field 1206. As discussed above, the promotion server 202 provides promotional information for sales of promotional items. In some instances, a promoter may specify that a promotion is to include more than one promotional item. In these instances, the promotional items may have different values. As a result of these different values, the promotion server 202 uses a weighted sales approach or point value approach to determine relationships among sales associates. The multiple item field 1206 provides a summary of the promotional items included within a promotion and the quantity of points assigned to each item. It should be appreciated that the promotion configurer 514, the promotion manager 522, the sales data processor 526, and the promotion processor 516 creates and operates promotions and processes promotional data for promotions that include multiple promotional items in the same manner as for promotions that include a single promotional item.

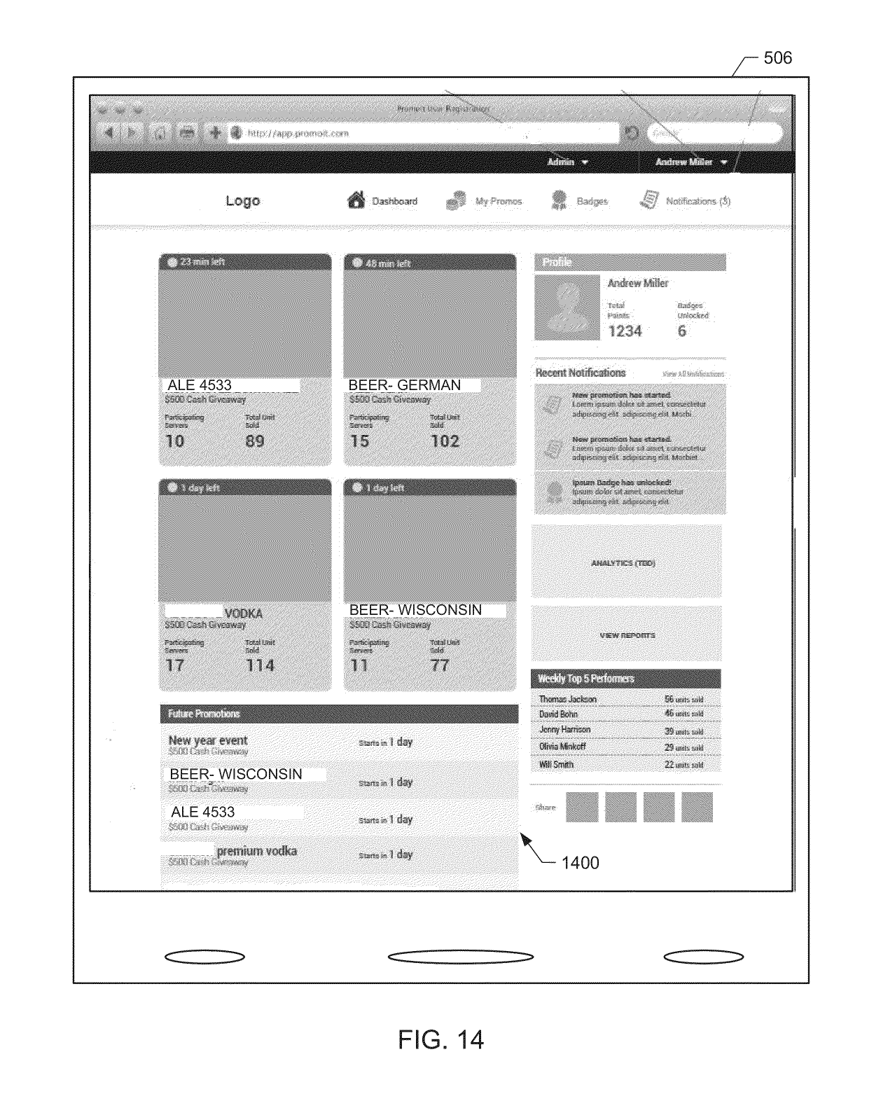

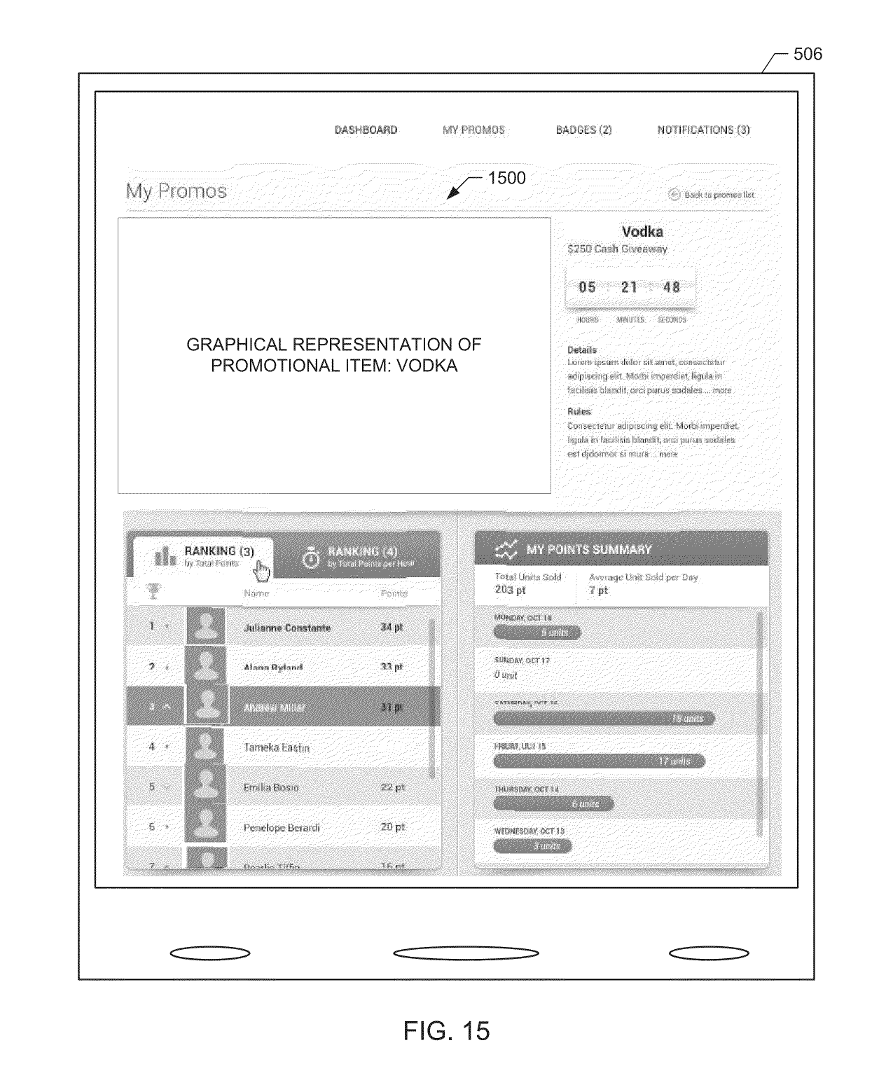

FIGS. 14 and 15 show diagrams of sales associate promotion web pages 1400 and 1500. In particular, the web page 1400 includes fields for promotions that the sales associate (i.e., Andrew Miller) has subscribed to or has participated. The web page 1400 also includes fields for future promotions the sale associate has been invited to or is otherwise eligible to participate. The web page 1400 further includes fields for analytics of sales of the sales associate and reports requested by the sales associate. The web page 1400 moreover includes a field for top performers of peers of the sales associate.

The sales associate may select any one of the current promotions to view the web page 1500, which shows specific sales associate information for that promotion. For example, the web page 1500 includes information regarding the promotion and an analytics section that provides the quantity of sales of the promotional item on a daily basis. The web page 1500 also includes a ranking of the sales associate compared to other sales associates for that promotion.

It should be appreciated that the web pages 1200, 1400, and 1500 could instead be implemented as an application that operates on the sale associate device 506. In these embodiments, the promotion manager 522 and/or the promotion processor 516 transmits the processed promotional data to the appropriate device 506 for display within the application. In other instances, the promotion manager 522 and/or the promotion processor 516 may provide the appropriate promotional data responsive to a request from the device 506.

### v) Award Determination

Responsive to determining an end of a promotional time period, the example promotion manager 522 is configured to send an indication of the end to the awards manager 518. The example awards manager 518 is configured to determine which sales associates are to be provided with which awards specified by a promoter. In many instances, the awards manager 518 uses programmed rules or natural language rules to determine how sales associates are to be awarded. The awards manager 518 accesses information stored in the data structures associated with the promotion and determines promotional sales data that corresponds to the rules. For instance, for a rule that specifies total sales, the awards manager 518 determines total sales for each sales associate. In another instance, for a rule that specifies highest sales per hour, the awards manager 518 accesses information stored in the data structures created by the promotion manager 522 or promotion processor 516 that includes analytics of sales associate sales per hour. In other instances, the awards manager 518 determines the sales/hour for each sales associate based on the promotional sales data parsed and sorted by the sales data processor 526.

Responsive to determining which of the sales associates qualify for an award, the awards manager 518 distributes the awards. To determine which awards are to be provided, the awards manager 518 determines from rules or information provided by a promoter (e.g., provide $500 to the top ranked sales associate) which award is assigned to which sales associate. As discussed above, a promoter specifies awards, which are then assigned an identifier by the promotion configurer 514. The identifier may include a link or reference to the award or a link or description specifying how an award can be accessed.

The example awards manager 518 provides a message to the sales associate including instructions as to how an award can be accessed or used. In some instances, the awards manager 518 may credit an account of the sales associates with the award. In other instances, the awards manager 518 may make arrangements (e.g., providing shipping information and contact a shipper) for an award to be shipped to a sales associate.

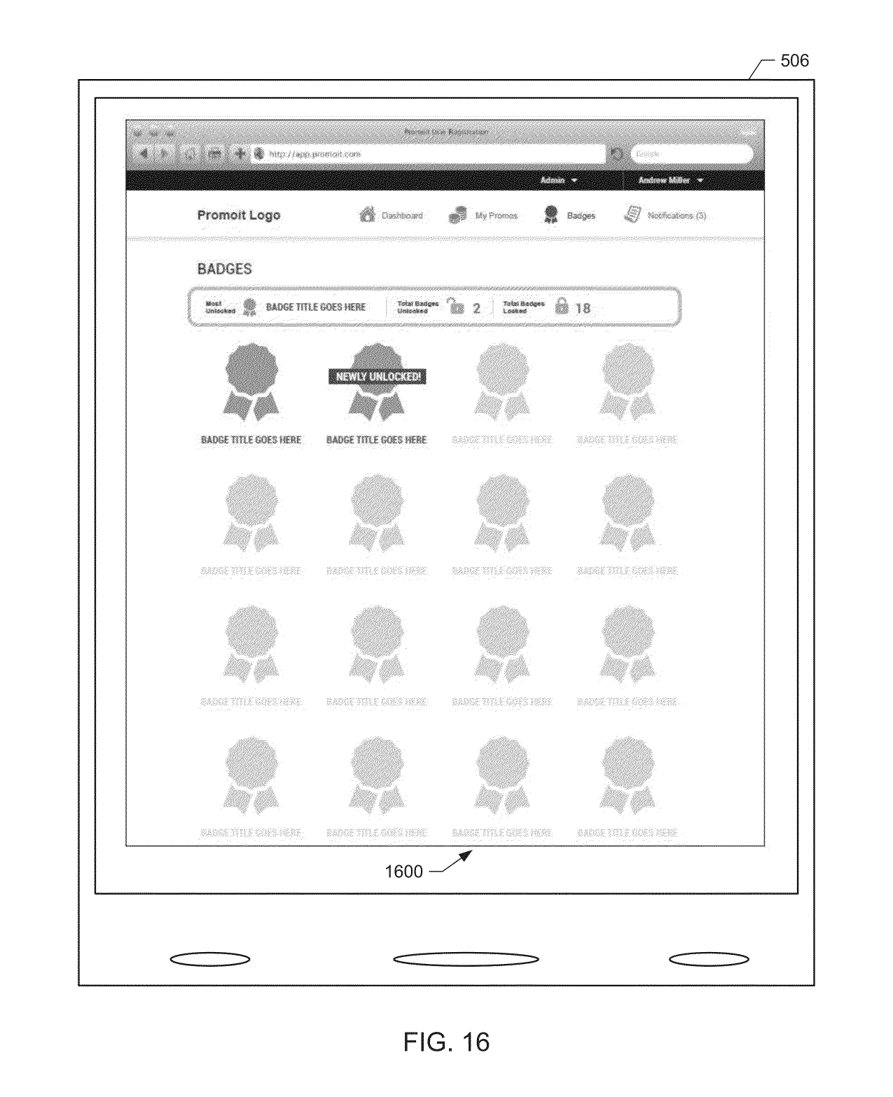

In addition to providing physical or tangible awards, the awards manager 518 may also provide virtual awards. FIG. 16 shows a diagram of an awards web page 1600 that is provided to a sales associate device 506 via the awards manager 518. The awards web page 1600 includes virtual badges or medals that are awarded to sales associates by achieving predetermined conditions. For example, the awards manager 518 may store or associate a badge to a profile of a sales associate for winning a promotion. The association of the badge causes the badge to appear on the awards web page 1600 of the sales associate.

The awards manager 518 may provide virtual awards as a result of a promotion. Alternatively, the awards manager 518 may provide virtual awards based on cumulative experience (similar to determining a level). For instance, the awards manager 518 may determine that a sales associate has finished in the top three for at least five promotions. In this instance, the awards manager 518 provides the appropriate virtual badge.

It should be appreciated that the awards web page 1600 provides a graphical representation of the achievements of a sales associate. The display of these achievements may motivate or encourage sales associates to earn additional badges. The display of these achievements may also encourage competition among sales associates. In some instances, the account manager 512 may enable a sales associate to provide a copy of the virtual badges to a social media application for further posterity.

### vi) Communication

The example promotion server 202 of FIG. 5 also enables promoters and/or retailers to communicate directly with sales associates. The example communication manager 520 is configured to process and route communications. In some examples, promotion web pages, promoter web pages, and/or sales associate web pages may include a message or chat function that is managed by the communication manager 520. Sales associates may use these communication features to communicate amongst each other and/or to send messages to a promoter.

For example, a promoter may want to know why a certain promotion is not going well in a few retail locations. The promoter uses the promotion system 502 to access a promotion page and post a message to the page or send a message to participating sales associates inquiring about the promotion. The communication manager 520 is configured to handle the processing and routing of the message. In response, the sales associates provide replies providing their opinions as to why a promotional item is not selling well.

In some instances, the profile or promotion web pages of the sales associates and the promoter may include a communication section. In these instances, the communication manager 520 is configured to enable a promoter system 502 to transmit one or more messages to sales associates participating in (or invited to participate) a promotion. The communication manager 520 displays the message from the promoter in the communication section of the web page for each sales associate. Similarly, the communication manager 520 enables sales associates to transmit messages. These messages may be routed to other sales associates associated with the promotion and/or the promoter. In other words, the communication manager 520 enables a string of messages from different sources to be concurrently displayed within a communication section of each sales associate and promoter associated with a promoter. Alternatively, the messages may only be provided to the promoter.

It should be appreciated that the communication manager 520 enables a promoter to communicate directly in real-time or near real-time with sales associates without using infrastructure of a retailer. Thus, the communication manager 520 enables a promoter to simultaneously communicate (sometimes with the same message) with sales associates at different retail locations and/or sale associates at different retailers. As a result of this configuration, a promoter can circumvent the multi-tier distribution environment (e.g., distributor, retailer, sales managers, etc.) to interface and communication directly with the sales associates participating in the promotion.

In addition to providing messaging, the communication manager 520 is also configured to process alerts and notifications. The promotion configurer 514 enables promoters and/or sales associates to specify conditions when they should receive an alert or notification. These conditions include for example, the launching of a new promotion that meet certain criteria, sales thresholds, ranking thresholds, etc. The example communication manager 520 monitors information stored in the data structures to determine when alert or notification conditions have been satisfied and sends the appropriate message to the promoter and/or sales associate.

### Processor

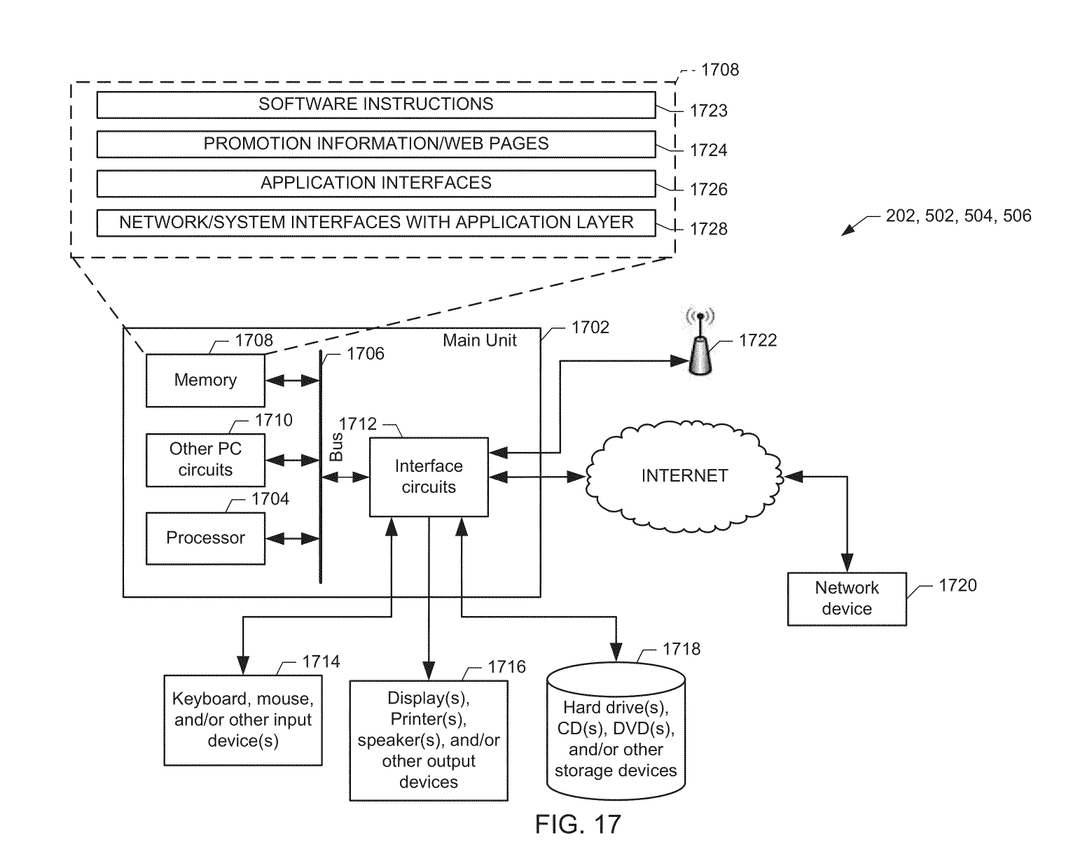

A detailed block diagram of electrical systems of an example computing device (e.g., the promotion server 202, the promoter system 502, the point-of-sale system 504, and/or the sales associate devices 506) is illustrated in FIG. 17. In this example, the promotion server 202, the promoter system 502, the point-of-sale system 504, and/or the sales associate devices 506 includes a main unit 1702 which includes one or more processors 1704 communicatively coupled by an address/data bus 1706 to one or more memory devices 1708, other computer circuitry 1710, and one or more interface circuits 1712. The processor 1704 may be any suitable processor, such as a microprocessor from the INTEL PENTIUM® or CORE™ family of microprocessors. The memory 1708 includes volatile memory and non-volatile memory. Preferably, the memory 1708 stores a software program that interacts with the other devices in the promotional environments 200 to 400 of FIGS. 2 to 4, as described above. This program may be executed by the processor 1704 in any suitable manner. In an example embodiment, memory 1708 may be part of a “cloud” such that cloud computing may be utilized by the promotion server 202, the promoter system 502, the point-of-sale system 504, and/or the sales associate devices 506. The memory 1708 may also store digital data associated with sales transactions, sales associate profile information, promoter profile information, promotional data, analytic data, web pages, etc. retrieved from the promotion server 202, the promoter system 502, the point-of-sale system 504, and/or the sales associate devices 506 and/or loaded via an input device 1714.

The example memory devices 1708 store software instructions 1723, records of promotional data/web pages, permissions, protocols, configurations, preference information, and/or application interface information 1726 (e.g., information for accessing and using the promotion system described herein). The memory devices 1708 also may store network or system interface features, permissions, protocols, configuration, and/or network interface information 1728 (e.g., information associated with the interface 511 and/or the point-of-sale system 504) for use by the promotion server 202, the promoter system 502, the point-of-sale system 504, and/or the sales associate devices 506. It will be appreciated that many other data structures and records may be stored in the memory device 1708 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 1712 may be implemented using any suitable interface standard, such as an Ethernet interface and/or a Universal Serial Bus (USB) interface. One or more input devices 1714 may be connected to the interface circuit 1712 for entering data and commands into the main unit 1702. For example, the input device 1714 may be a keyboard, mouse, touch screen, track pad, track ball, isopoint, image sensor, character recognition, barcode scanner, microphone, and/or a speech or voice recognition system.

One or more displays, printers, speakers, and/or other output devices 1716 may also be connected to the main unit 1702 via the interface circuit 1712. The display may be a cathode ray tube (CRTs), a liquid crystal display (LCD), or any other type of display. The display generates visual displays generated during operation of the promotion server 202, the promoter system 502, the point-of-sale system 504, and/or the sales associate devices 506. For example, the display may provide a user interface and may display promotion web pages hosted by the promotion server 202. A user interface may include prompts for human input from a user of the promoter system 502 and/or devices 506 including links, buttons, tabs, checkboxes, thumbnails, text fields, drop down boxes, etc., and may provide various outputs in response to the user inputs, such as text, still images, videos, audio, and animations.

One or more storage devices 1718 may also be connected to the main unit 1702 via the interface circuit 1712. For example, a hard drive, CD drive, DVD drive, and/or other storage devices may be connected to the main unit 1702. The storage devices 1718 may store any type of data, such as promotion data, transaction data, operations data, profile information, statistical data, security data, etc., which may be used by the promotion server 202, the promoter system 502, the point-of-sale system 504, and/or the sales associate devices 506.

The promotion server 202, the promoter system 502, the point-of-sale system 504, and/or the sales associate devices 506 may also exchange data with other network devices 1720 via a connection to the Internet or a wireless transceiver 1722 connected to the Internet. Network devices 1720 may include one or more servers, which may be used to store certain types of data, and particularly large volumes of data which may be stored in one or more data repository. A server may include any kind of data including databases, programs, files, libraries, records, images, documents, requirements, promotional data, operations data, configuration data, index or tagging data, purchase information, promotional item information, statistical data, security data, etc. A server may store and operate various applications relating to receiving, transmitting, processing, and storing the large volumes of data. It should be appreciated that various configurations of one or more servers may be used to support and maintain, for example, the promotion server 202 of FIG. 5. For example, servers may be operated by various different entities. Also, certain data may be stored in the promotion server 202, the promoter system 502, the point-of-sale system 504, and/or the sales associate devices 506 which is also stored on a server, either temporarily or permanently, for example in memory 1708 or storage device 1718. The network connection may be any type of network connection, such as an Ethernet connection, digital subscriber line (DSL), telephone line, coaxial cable, wireless connection, etc.

Access to the promotion server 202, the promoter system 502, the point-of-sale system 504, and/or the sales associate devices 506 can be controlled by appropriate security software or security measures. An associate users' access can be defined by the promotion server 202, the promoter system 502, the point-of-sale system 504, and/or the sales associate devices 506 and limited to certain data and/or actions. Accordingly, users or consumers of the disclosed promotional system may be required to register with one or more of the promotion server 202, the promoter system 502, the point-of-sale system 504, and/or the sales associate devices 506.

### Flowchart of Promotion Creation Embodiment

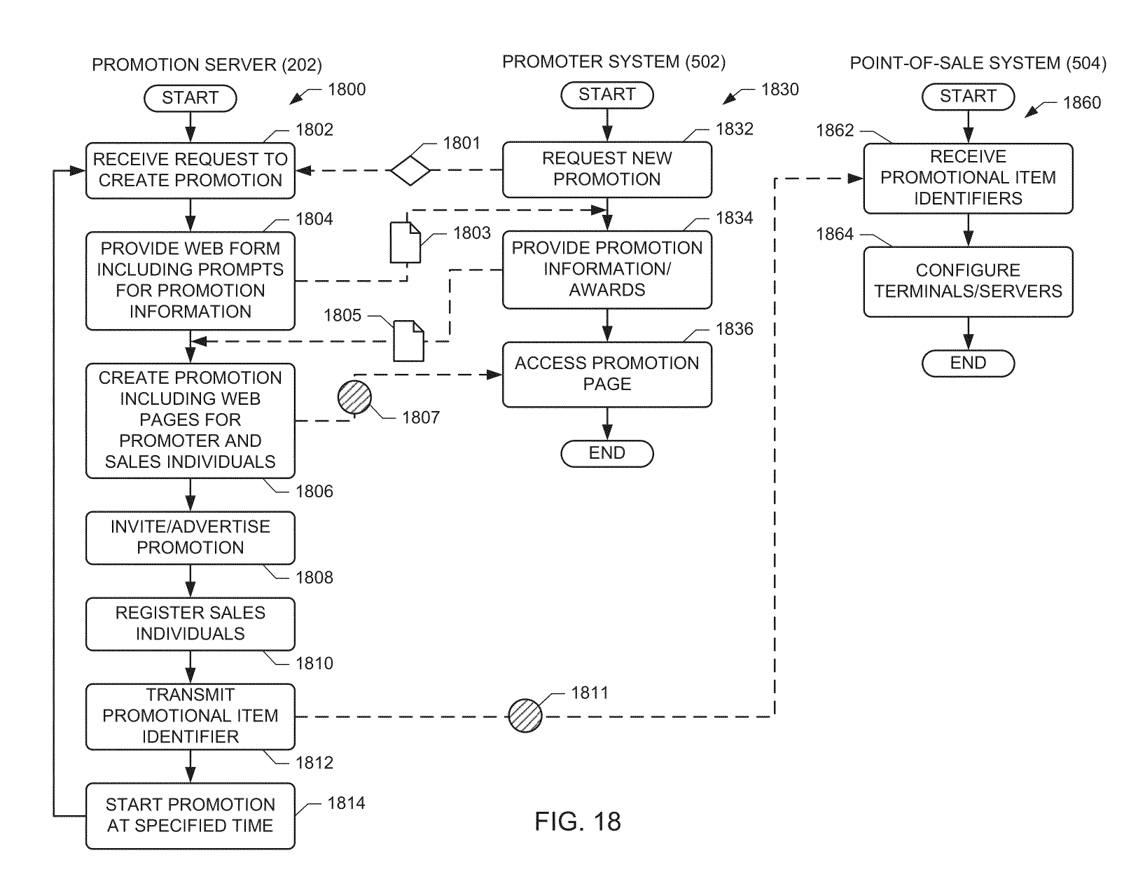

FIG. 18 is a flow diagram illustrating example procedures 1800, 1830, and 1860 to create a promotion, according to an example embodiment of the present disclosure. The example procedures 1800, 1830, and 1860 may be carried out by, for example, the promotion server 202, the promoter system 502, and the point-of-sale system 504 described in conjunction with FIGS. 2 to 17. Although the procedures 1800, 1830, and 1860 are described with reference to the flow diagram illustrated in FIG. 18, it will be appreciated that many other methods of performing the functions associated with the procedures 1800, 1830, and 1860 may be used. For example, the order of many of the blocks may be changed, certain blocks may be combined with other blocks, and many of the blocks described are optional.

The procedure 1800 begins when the promotion server 202 receives a request message 1801 from the promoter system 502 to create a promotion (block 1802). The request message 1801 can be provided by the promoter system 502 selecting a ‘create promotion’ icon in a promoter profile web page or application. Responsive to receiving the request message 1801, the promotion server 202 provides a form 1803 (e.g., a web form or application form) prompting the promotion system 502 for promotion information (block 1804). As discussed above, the promotion information includes a description of a promotion/promotional item, a promotional time period, promotion rules, promotion awards, a specification of the promotional item, and/or sales associates to participate (or invited to participate) in the promotion.

Responsive to receiving the requested promotion information 1805, the promotion server 202 creates a promotion (block 1806). As discussed above in conjunction with FIG. 5, creating the promotion includes creating one or more promotion web pages or applications 1807 for sales associates and/or the promoter system 502 based on the received promotion information 1805. In some embodiments, the promotion server 202 uses web-based templates (e.g., an Extensible Markup Language (“XML”) template) to create the promotion web page(s) 1807.

After creating the promotion, the promotion server 202 invites sales associates to participate and/or advertises the promotion (block 1808). Inviting sales associates may include providing a web page function on profile pages of appropriate sales associates with an option to subscribe to a promotion or register for the promotion. Advertising the promotion can also include displaying the promotion within a future promotions field of a profile page of appropriate sales associates and/or sending associates a text or e-mail message. Responsive to receiving registration requests, the example promotion server 202 registers the sales associates for the promotion (block 1810).

The promotion server 202 also transmits messages 1811 including identifiers (e.g., SKUs) of the promotional items associated with the promotion to one or more point-of-sale systems 504 (block 1812). The promotion server 202 determines which point-of-sale systems 504 are to receive the messages 1811 based on which retailers and/or sales associates were provided by the promoter system 502 within promotion information 1803. As discussed above, the identifiers are used by the systems 504 to determine which sale transactions correspond to a promotion. In instances where the promotion server 202 instead parses transaction data for promotional item SKUs, this step may be skipped.

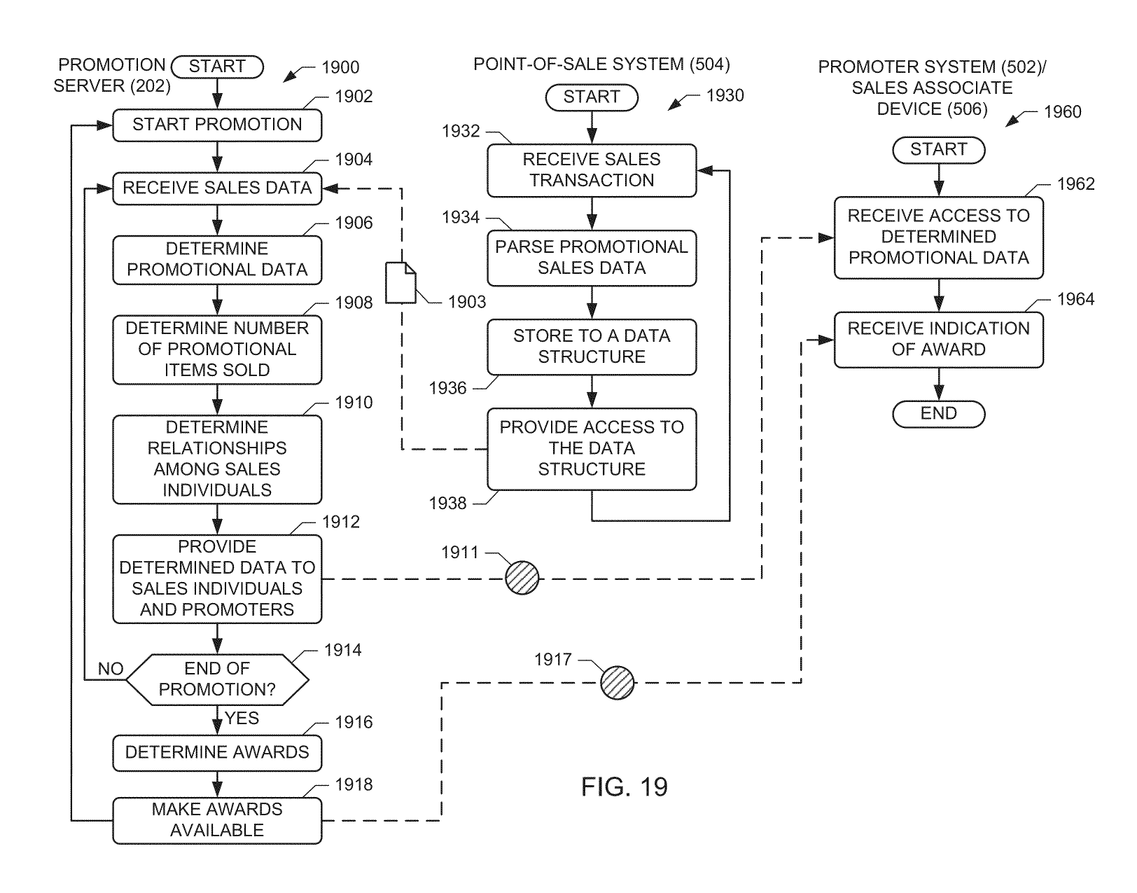

The example promotion server 202 then determines a start time for the promotion and begins the management of the promotion at this time (block 1814). Procedures 1900, 1930, and 1960 of FIG. 19 describe example steps performed during a promotional time period. After the promotion server 202 begins the promotion, the promotion server 202 returns to creating another promotion. However, it should be appreciated that the promotion server 202 may have the capability to create promotions in parallel for the same or different promotion systems 502. In other embodiments, the example procedure 1800 ends.

The example procedure 1830 begins when a promoter system 502 requests to create a new promotion (block 1832). The request includes transmitting a request message 1801 to the promotion server 202. Responsive to receiving a form 1803 from the promotion server 202, the promoter system 502 provides promotion information 1805 regarding the promotion (block 1834). The promoter system 502 may also send an operator of the promotion server 202 physical awards (e.g., money, prizes, etc.). After the promotion server 202 has created the promotion, the promoter system 502 accesses one or more promotion web pages 1807 to manage and/or view a status of the promotion (block 1836). The example procedure 1830 then ends. In other embodiments, the promoter system 502 may create another promotion.

The example procedure 1860 begins when the example point-of-sale system 504 receives one or more messages 1811 including identifiers of promotional items from the promotion server 202 (block 1862). The point-of-sale system 504 uses the identifier to configure the point-of sale servers 510 and terminals 508 to identify promotional items (block 1864). For example, the terminals 508 and/or servers 510 may store portions of a transaction that relate to a promotional item to a data structure after detecting that the transaction includes an identified promotional item.

The messages 1811 may also include a time period during which products/services are to be classified as promotional items. As a result of this time information, the servers 510 and/or the terminals 508 may only store information indicative of the transaction of the promotional item during the specified time period. At this point, the example procedure 1860 then ends. In other embodiments, the example procedure 1860 returns to receiving additional identifiers of promotional items.

Alternatively, the promotion server 202 does not provide the point-of-sale system 504 with identifiers of promotional items. In these instances, where the promotion server 202 is configured to parse transaction data, the point-of-sale system 504 instead transmits substantially all transaction data for the promotion server 202 to process. The point-of-sale system 504 may alternatively enable the promotion server 202 to read or otherwise access stored transaction data.

### Flowchart of Promotion Management Embodiment

FIG. 19 is a flow diagram illustrating example procedures 1900, 1930, and 1960 to manage a promotion, according to an example embodiment of the present disclosure. The example procedures 1900, 1930, and 1960 may be carried out by, for example, the promotion server 202, the sales associate devices 506, and the point-of-sale system 504 described in conjunction with FIGS. 2 to 17. Although the procedures 1900, 1930, and 1960 are described with reference to the flow diagram illustrated in FIG. 19, it will be appreciated that many other methods of performing the functions associated with the procedures 1900, 1930, and 1960 may be used. For example, the order of many of the blocks may be changed, certain blocks may be combined with other blocks, and many of the blocks described are optional.

The procedure 1900 begins when the promotion server 202 begins a promotion (block 1902). After the promotion has begun, the promotion server 202 receives and processes sales data 1903 of promotional item(s) associated with the promotion (block 1904). As discussed above, the promotion server 202 receives the sales data included within one or more data structures from point-of-sale systems 504. The promotion server 202 analyzes the received sales data 1903 to extract relevant promotional sales data (block 1906). The promotion server 202 may store the extracted data to one or more data structures for each promotional item, sales associate, retailer, etc.

The promotion server 202 then determines a quantity of promotional items sold for each of the sales associates participating in the promotion (block 1908). The promotion server 202 also determines relationships among the sales associates participating in the promotion (block 1910). The promotion server 202 stores and provides the determined sales quantities and relationship data to the appropriate sales associates and promoters in one or more web pages 1911 (block 1912). As discussed above, the promotion server 202 could provide the data in a promoter-specific web page (e.g., the web page 2000) and in sales associate-specific web pages (e.g., the web pages 1400 and 1500). In other embodiments, the promotion server 202 transmits the promotional data to applications operating on (or accessible by) a promoter system 502 and/or sales associate devices 506.

The example promotion server 202 next determines if the promotional time period is expired (block 1914). If the time period is not expired, the promotion server 202 continues to receive and process sales data 1303 from point-of-sale systems 504 (block 1904). However, if the promotional time period has expired, the promotion server 202 determines which of the sales associates are to receive awards (block 1916). The promotion server 202 performs the award determination by determining which sales associates have sales of promotional items that match award rules specified by the promoter. In some instances, the promotion server 202 analyzes promotional sales data (e.g., determine a highest sales/hour average among the sales associates) to determine which sales associates are awarded.

The promotion server 202 then provides the awards to the appropriate sales associates (block 1918). In some embodiments, the promotion server 202 transmits award notification messages 1917 to the winning sales associates. These messages can include a link or information for accessing the award. The notification messages 1917 can also include providing a virtual award to an award page of the winning sales associates.

The example promotion server 202 then returns to block 1902 for the next promotion. However, it should be appreciated that in some embodiments, the promotion server 202 is configured to operate or manage multiple promotions in parallel. In alternative embodiments, the example procedure 1900 ends after the promotion server 202 has provided awards for a promotion.

The example procedure 1930 begins when the point-of-sale system 504 receives sales transactions from sales associates at point-of-sale terminals 508 (block 1932). The point-of-sale system 504 parses the transactions for promotional sales data (block 1934). Parsing the transactions may include, for example, identifying the portion of the transaction that is associated with one or more promotional items. The point-of-sale system 504 stores this parsed information to one or more data structures (block 1936). The point-of-sale system 504 then provides the promotion server 202 access to the information stored in the data structures (block 1938). The promotion server 202 uses this access to download or otherwise receive the sales data 1903.

In alternative examples, the point-of-sale system 504 may not parse transactions for promotional items. In these alternative examples, the point-of-sale system 504 provides the promotion server 202 access to substantially all stored transactions. The promotion server 202 then parses the sales data 1903 for the promotional items and corresponding data.

The example point-of-sale system 504 continues to provide sales data until a promotion has ended. After a promotion has ended, the point-of-sale system 504 changes how the transactions are parsed so that the promotional item(s) associated with the newly terminated promotion are no longer identified. The point-of-sale system 504 may later receive an indication of another promotion (either from the promotion server 202, the promoter system 520, or provided by a manager/user) and subsequently configures how transactions are parsed so that promotional item(s) associated with the new promotion are identified. In examples where the point-of-sale system 504 does not search for promotional items, the example procedure 1930 continues until the promotion server 202 no longer needs sales data from the point-of-sale system 504.

The example procedure 1960 begins when a promoter system 502 and/or sales associate devices 506 receive access to promotional data made available by the promotion server (block 1962). The promotional data may be made available through one or more web pages 1911 that display a real-time or near real-time update of a status of a promotion including sales of promotional items and relationships among the participating sales associates At the end of the promotional time period, the sales associate devices 506 associated with awarded sales associates receive award notification messages 1917 indicating how an award is to be received or accessed (block 1964). Additionally, the promoter system 502 receives an award notification message 1917 indicating which sales associates were awarded. The example procedure 1960 then ends for the promotion. In other examples, the procedure 1960 returns to block 1962 for the next promotion.

### CONCLUSION

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
receiving in a server an indication of a sale of a promotional item from a sales terminal, the promotional item being specified by a promoter for a promotional competition to be carried out by a group of sales associates, the indication including an identifier of a sales associate included within the group of sales associates who sold the promotional item;
determining a quantity of the promotional items sold by the sales associate based on the received indication and a previous quantity of the promotional items sold by the sales associate;
determining relationships among the group of sales associates based on the quantity of promotional items sold by the sales associates; and
sending to a computer system of the promoter information indicative of the quantity of promotional items sold respectively by the sales associates and information indicative of the determined relationship among the group of sales associates,
wherein the promoter is remotely located from the group of sales associates.

2. The method of claim 1, wherein the group of sales associates is employed by an organization that is separate and distinct from the promoter.

3. The method of claim 1, wherein the determined relationships includes a ranking of the sales associate among each other based on sales of the promotional item.

4. The method of claim 1, further comprising:
determining an end of a time period for selling the promotional item;
determining a final quantity of promotional items sold by the sales associate; and
providing an award to the sales associate if the final quantity is greater than a predetermined threshold.

5. The method of claim 1, further comprising:
determining an end of a time period for selling the promotional item;
determining final relationships among the group of sales associates based on the total quantity of promotional items sold by each sales associate; and
providing an award to at least one sales associate based on the final relationships.

6. The method of claim 5, wherein the award is an icon indicative of the final relationship and is displayed in conjunction with an online profile of the sales associate.

7. The method of claim 1, further comprising providing for display on a profile page associated with the promoter at least one of:
(i) the quantity of promotional items sold respectively by the sales associates,
(ii) the relationships among the sales associates,
(iii) a quantity of sales associates that have sold the promotional item,
(iv) a total quantity of the promotional items sold, and
(v) a quantity of the promotional items sold among a first portion of the group of sales associates associated with a first retail location and a second portion of the group of sales associates associated with a second retail location.

8. The method of claim 7, further comprising updating the profile page of the promoter responsive to receiving the indication of the sale of the promotional item by at least one of the sales associates.

9. The method of claim 7, further comprising providing for display on the profile page associated with the promoter at least one of:
(i) a quantity of second promotional items sold respectively by the sales associates of a second group that is different from the group of sales associates, the second promotional item being different from the first promotional item,
(ii) the relationship among the sales associates of the second group,
(iii) a quantity of sales associates of the second group that have sold the second promotional item, and
(iv) a total quantity of the second promotional items sold.

10. The method of claim 9, further comprising:
determining a final total relationship among each of the sales associates within the group and the second group based on the total quantity of promotional items and second promotional items sold by each sales associate; and
providing a second award to at least one sales associate based on the final total relationship.

11. An apparatus comprising:
a promotion server communicatively coupled to a point-of-sale system remotely located at a first location and communicatively coupled to a promoter system remotely located at a second location, the promotion server configured to:
(a) host a promotional competition having a predetermined time period for a group of sales associates associated with the point-of-sale system, the promotional competition being specified by the promoter system including the time period and a promotional item;
(b) receive sales data included within data structures indicative of sales of the promotional item from the point-of-sale system during the time period, the sales data including identifiers of the promotional item and identifiers of the sales associates that sold the promotional item;
(c) responsive to receiving at least some sales data, determine a quantity of the promotional items sold respectively by the sales associates based on the sales data;
(d) determine relationships among the sales associates based on the quantity of the promotional items sold respectively by the sales associates; and
(e) transmit to the promoter system information indicative of the quantity of promotional items sold by each of the sales associates and information indicative of the determined relationships among the group of sales associates.

12. The apparatus of claim 11, wherein the promotion server is distributed among one or more processors within a cloud computing network.

13. The apparatus of claim 11, wherein the promotion server is operated by a third party, the promotion server being separate and distinct from the promoter system and the point-of-sale system.

14. The apparatus of claim 11, wherein the point-of-sale system includes at least one point-of-sale terminal that is configured to process a transaction of the promotional item by storing to the data structure at least one of the identifier of the promotional item, a quantity of the promotional item sold in the transaction, the identifier of the sales associate associated with the transaction, a price of the promotional item, a date of the transaction, and a time of the transaction.

15. The apparatus of claim 14, wherein the point-of-sale system is configured to:
store to data structures the sales data from the at least one point-of-sale terminal; and
transmit the sales data included within the data structures to the promotion server at a predetermined time.

16. The apparatus of claim 11, wherein the promotion server is configured to:
detect the transaction through an interface with the point-of-sale system; and
responsive to detecting the transaction, causing the sales data within the data structure to be transmitted from the point-of-sale system to the promotion server.

17. The apparatus of claim 11, wherein the promoter system includes a retailer and the sales associate is associated with the retailer.

18. The apparatus of claim 11, wherein the promoter system includes at least one of a manufacturer and a distributor of the promotional item and the sales associate is associated with a retailer that offers the promotional item for sale.

19. The apparatus of claim 11, wherein the promotion server is configured to:
after the time period has expired, determine award sales associates among the group of sale associates based on the determined relationship at the end of the time period, the promoter system providing criteria for determining the award sales associates; and
provide awards to the award sales associates.

20. The apparatus of claim 19, wherein the awards include a badge displayable on online profile pages associated with the corresponding award sales associates.

21. The apparatus of claim 19, wherein the awards include a level-up based on the quantity of sales and the determined relationship.

22. The apparatus of claim 11, wherein the promotion server is included within a multi-tier distribution system that includes a manufacturer, a distributor, and a retailer that employs the sales associates, the manufacturer being the promoter.

23. The apparatus of claim 11, wherein the promotional item includes an alcoholic beverage, the manufacturer produces the alcoholic beverage, the distributor transports the alcoholic beverage to the retailer, and the sales associates sell the alcoholic beverage.

24. A machine-accessible device having instructions stored thereon that are configured, when executed, to cause a machine to at least:
receive from a promoter system information regarding a promotion, the information including at least one of an identifier of a promotional item, a promotional time period, an award for the promotion, and a rule providing conditions for receiving the award;
configure the promotion based on the received information;
provide information indicative of the promotion and to sales associates;
receive sales data indicative of sales of the promotional item from at least one point-of-sale system associated with the sales associates;
determine a quantity of the promotional items sold by each of the sales associates based on the sales data; and
transmit to the promoter system information indicative of the quantity of promotional items sold respectively by the sales associates.

25. The machine-accessible device of claim 24, further comprising instructions stored thereon that are configured when executed to cause the machine to:
provide the promotion to the sales associates through a hosted application; and
transmit the quantity of promotional items sold to the promoter system though the hosted application.

26. The machine-accessible device of claim 24, further comprising instructions stored thereon that are configured when executed to cause the machine to:
receive profile information from each of the sales associates;
create a profile page for each of the sales associates based on the received profile information; and
provide the quantity of promotional items sold by the sales associate to the respective profile page.

27. The machine-accessible device of claim 26, further comprising instructions stored thereon that are configured when executed to cause the machine to:
receive a message from the promoter system, the message including information associated with the promotion; and
providing the message to the profile page for each of the sales associates.

28. The machine-accessible device of claim 27, further comprising instructions stored thereon that are configured when executed to cause the machine to:
receive a second message from one of the sales associates via the respective profile page, the message including a response to the message from the promoter system; and
providing the message to a profile page for the promoter system.

29. The machine-accessible device of claim 26, wherein the profile page includes at least some information associated with the promotion, an option to subscribe to a second promotion, a ranking of the sales associate in comparison to other sales associates, and a time remaining for the promotion.

30. The machine-accessible device of claim 24, further comprising instructions stored thereon that are configured when executed to cause the machine to:
receive profile information from the promoter system;
create a profile page for the promoter system; and
provide the quantity of promotional items sold by the sales associates to the profile page of the promoter system.
